(19) United States
(12) Patent Application Publication
(10) Pub. No.: US 2024/0292481 A1
(43) Pub. Date: Aug. 29, 2024

(54) TECHNIQUES TO INDICATE REPETITION OF MESSAGES

(71) Applicant: QUALCOMM Incorporated, San Diego, CA (US)

(72) Inventors: Mohamad SAYED HASSAN, Paris (FR); Liangping MA, San Diego, CA (US); Lianghai JI, San Diego, CA (US); Jun MA, San Diego, CA (US)

(21) Appl. No.: 18/174,563

(22) Filed: Feb. 24, 2023

(51) Int. Cl. H04W 76/20; H04W 72/1273

(52) U.S. Cl. CPC H04W 76/20; H04W 72/1273

(57) ABSTRACT

Apparatus, methods, and computer-readable media for indicating repetition for messages without relying on RRC signaling are disclosed herein. An example method for wireless communication at a UE includes receiving, before performing an RRC configuration procedure or an RRC reconfiguration procedure, a first communication scheduling a first data transmission with associated feedback. The first communication may include first information associated with the first data transmission and a first redundancy version indicator (rv Index). The example method also includes attempting to receive the first data transmission based on the first information. The example method also includes transmitting, based on the first rv Index, a first quantity of repetitions of first data feedback for the first data transmission.

### INTRODUCTION

The present disclosure relates generally to communication systems, and more particularly, to wireless communication employing repetition for feedback.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method of wireless communication at a user equipment (UE) is provided. The method may include receiving, before performing a radio resource control (RRC) configuration procedure or an RRC reconfiguration procedure, a first communication scheduling a first data transmission with associated feedback, the first communication including first information associated with the first data transmission and a first redundancy version indicator (rv Index). The example method may also include attempting to receive the first data transmission based on the first information. Additionally, the example method may include transmitting, based on the first rv Index, a first quantity of repetitions of first data feedback for the first data transmission.

In another aspect of the disclosure, an apparatus for wireless communication is provided. The apparatus may be a UE that includes a memory and at least one processor coupled to the memory, the at least one processor configured to receive, before performing an RRC configuration procedure or an RRC reconfiguration procedure, a first communication scheduling a first data transmission with associated feedback, the first communication including first information associated with the first data transmission and a first rv Index. The at least one processor may also be configured to attempt to receive the first data transmission based on the first information. Additionally, the at least one processor may be configured to transmit, based on the first rv Index, a first quantity of repetitions of first data feedback for the first data transmission.

In another aspect of the disclosure, an apparatus for wireless communication at a UE is provided. The apparatus may include means for receiving, before performing an RRC configuration procedure or an RRC reconfiguration procedure, a first communication scheduling a first data transmission with associated feedback, the first communication including first information associated with the first data transmission and a first rv Index. The example apparatus may also include means for attempting to receive the first data transmission based on the first information. Additionally, the example apparatus may include means for transmitting, based on the first rv Index, a first quantity of repetitions of first data feedback for the first data transmission.

In another aspect of the disclosure, a non-transitory computer-readable storage medium storing computer executable code for wireless communication at a UE is provided. The code, when executed, may cause a processor to receive, before performing an RRC configuration procedure or an RRC reconfiguration procedure, a first communication scheduling a first data transmission with associated feedback, the first communication including first information associated with the first data transmission and a first rv Index. The example code, when executed, may also cause the processor to attempt to receive the first data transmission based on the first information. Additionally, the example code, when executed, may cause the processor to transmit, based on the first rv Index, a first quantity of repetitions of first data feedback for the first data transmission.

In an aspect of the disclosure, a method of wireless communication at a network entity is provided. The method may include outputting, before performing an RRC configuration procedure or an RRC reconfiguration procedure, a first communication scheduling a first data transmission with associated feedback, the first communication including first information associated with the first data transmission and a first rv Index. The example method may also include outputting the first data transmission based on the first information. Additionally, the example method may include obtaining, based on the first rv Index, a first quantity of repetitions of first data feedback for the first data transmission.

In another aspect of the disclosure, an apparatus for wireless communication is provided. The apparatus may be a base station that includes a memory and at least one processor coupled to the memory, the at least one processor configured to output, before performing an RRC configuration procedure or an RRC reconfiguration procedure, a first communication scheduling a first data transmission with associated feedback, the first communication including first information associated with the first data transmission and a first rv Index. The at least one processor may also be configured to output the first data transmission based on the first information. Additionally, the at least one processor may be configured to obtain, based on the first rv Index, a first quantity of repetitions of first data feedback for the first data transmission.

In another aspect of the disclosure, an apparatus for wireless communication at a base station is provided. The apparatus may include means for outputting, before performing an RRC configuration procedure or an RRC reconfiguration procedure, a first communication scheduling a first data transmission with associated feedback, the first communication including first information associated with the first data transmission and a first rv Index. The example apparatus may also include means for outputting the first data transmission based on the first information. Additionally, the example apparatus may include means for obtaining, based on the first rv Index, a first quantity of repetitions of first data feedback for the first data transmission.

In another aspect of the disclosure, a non-transitory computer-readable storage medium storing computer executable code for wireless communication at a base station is provided. The code, when executed, may cause a processor to output, before performing an RRC configuration procedure or an RRC reconfiguration procedure, a first communication scheduling a first data transmission with associated feedback, the first communication including first information associated with the first data transmission and a first rv Index. The example code, when executed, may also cause the processor to output the first data transmission based on the first information. Additionally, the example code, when executed, may cause the processor to obtain, based on the first rv Index, a first quantity of repetitions of first data feedback for the first data transmission.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network (NW).

FIG. 2 shows a diagram illustrating architecture of an example of a disaggregated base station.

FIG. 3A is a diagram illustrating an example of a first subframe within a 5G NR frame structure.

FIG. 3B is a diagram illustrating an example of DL channels within a 5G NR subframe.

FIG. 3C is a diagram illustrating an example of a second subframe within a 5G NR frame structure.

FIG. 3D is a diagram illustrating an example of UL channels within a 5G NR subframe.

FIG. 4 is a block diagram that illustrates an example of a first wireless device that is configured to exchange wireless communication with a second wireless device.

FIG. 5A is a diagram illustrating a communication flow between a network entity and a UE implementing a four-step RACH procedure, in accordance with the teachings disclosed herein.

FIG. 5B is a diagram illustrating a communication flow between the network entity and the UE implementing a two-step RACH procedure, in accordance with the teachings disclosed herein.

FIG. 6 illustrates an example communication flow between a network entity and a UE, in accordance with the teachings disclosed herein.

FIG. 7A is a diagram illustrating an example of redundancy version cycling based on PDSCH transmission occasions, in accordance with the teachings disclosed herein.

FIG. 7B is a diagram illustrating an example table associated with redundancy version cycling, in accordance with the teachings disclosed herein.

FIG. 7C is a diagram illustrating an example circular buffer, in accordance with the teachings disclosed herein.

FIG. 8 is a diagram of a table illustrating linking between a codepoint, an rv Index, and a repetition factor, in accordance with the teachings disclosed herein.

FIG. 9 illustrates an example communication flow between a network entity and a UE, in accordance with the teachings disclosed herein.

FIG. 10A is a flowchart of a method of wireless communication, in accordance with the teachings disclosed herein.

FIG. 10B is a flowchart of a method of wireless communication, in accordance with the teachings disclosed herein.

FIG. 11 is a diagram illustrating an example of a hardware implementation for an example apparatus and/or network entity, in accordance with the teachings disclosed herein.

FIG. 12A is a flowchart of a method of wireless communication, in accordance with the teachings disclosed herein.

FIG. 12B is a flowchart of a method of wireless communication, in accordance with the teachings disclosed herein.

FIG. 13 is a diagram illustrating an example of a hardware implementation for an example network entity, in accordance with the teachings disclosed herein.

FIG. 14 is a diagram illustrating example fields of a DCI that may schedule a data transmission with associated feedback, in accordance with the teachings disclosed herein.

### DETAILED DESCRIPTION

A wireless communication system may include a network entity and a UE. The network entity may provide a cell on which the UE may operate. In order to communicate in the wireless communication system, the network entity and the UE may acquire a timing advance for uplink signals. The network entity and the UE may acquire timing synchronization (e.g., uplink timing synchronization) through a random access procedure. For example, the UE may initiate the random access procedure for initial access to the cell provided by the network entity, radio resource control (RRC) connection reestablishment, handover from another network entity to the network entity, reacquisition of timing synchronization, transition from an RRC Inactive state, SCell timing alignment, request for Other System Information (SI), and/or beam failure recovery.

In certain aspects, the random access procedure may be a four-step random access channel (RACH) procedure in which the UE and the network entity exchange four messages (e.g., a msg1, a msg2, a msg3, and a msg4). In certain aspects, the random access procedure may be a two-step RACH procedure in which the UE and the network entity exchange two messages (e.g., a msgA and a msgB).

In some examples, the UE may be configured to transmit feedback (e.g., an acknowledgement (ACK) or a negative ACK (NACK)) for a RACH transmission. In some examples, the UE may be configured to transmit feedback for a last RACH transmission of a RACH procedure (e.g., the msg4 or the msgB). The feedback may indicate to the network entity whether the RACH procedure is complete.

In some examples, RACH procedures may have coverage limitations, which may impact network performance. Examples of coverage limitations include channel conditions, a link budget, a pathloss threshold, a reference signal received power (RSRP) threshold, an initial RACH transmission target power, etc. Additionally, in one or more aspects, downlink coverage may be higher than uplink coverage. For example, a network entity may be configured with more capabilities, compared to a UE, to utilize coverage enhancement techniques (e.g., repeated transmissions, feedback repetitions, power boosting, beamforming, etc.) to overcome some coverage limitations. In such examples with coverage limitations, RACH messages may be missed by the UE and/or the network entity, or may be inaccurately decoded. For example, the feedback for the last RACH transmission may be missed by the network entity (e.g., due to the coverage limitations).

Thus, the network entity and the UE may use repetitions to improve reliability. Repetition may improve reliability because repetitions increase the probability of successful reception of a transmission, such as the feedback. As used herein, the term “repetition” refers to the initial transmission and is also used to refer to a repeated transmission of the initial transmission. For example, if a UE is configured to transmit four repetitions, then the UE may transmit an initial transmission and may transmit three repeated transmissions of that initial transmission.

In some examples, the UE may be configured with a set of repetition factors associated with the feedback (e.g., msg4 feedback or msgB feedback). A repetition factor may indicate a quantity or number of repetitions. The set of repetition factors may include at least two repetition factors. In some examples, the UE may be configured with multiple sets of repetition factors associated with different feedback. For example, the UE may be configured with a first set of repetition factors associated with msg4 feedback and may be configured with a second set of repetition factors associated with msgB feedback.

Aspects disclosed herein facilitate a network entity indicating a repetition factor for a UE to apply to the feedback for a last transmission of a RACH procedure (e.g., the msg4 or the msgB) when the UE is configured with multiple repetition factors. For example, the network entity may indicate the repetition factor to apply dynamically via downlink control information (DCI) scheduling the data for the msg4 or the msgB via a physical downlink shared channel (PDSCH). Additionally, one or more aspects disclosed herein facilitate indicating the repetition factor to apply without impacting the size of the DCI. For example, according to one or more aspects, the network entity may indicate the repetition factor without adding a new information element. That is, the network entity may indicate the repetition factor using existing fields that are already included in the DCI scheduling the RACH data transmission (e.g., the msg4 PDSCH or the msgB PDSCH).

For example, one example of an existing field of the DCI includes a redundancy version (RV) codepoint (e.g., a value of the field) to indicate a redundancy version to be applied to a corresponding PDSCH transmission. A redundancy version may indicate an amount of redundancy added into data while encoding the data and before transmitting the data. The redundancy version may also be referred to as an “rv Index,” an “RV identifier,” or an “RVID.” In one or more aspects, a redundancy version may indicate one or more parity bits that a UE receiving a PDSCH transmission may use to decode the PDSCH transmission.

Aspects disclosed herein facilitate linking a redundancy version indicated by the DCI scheduling the RACH data transmission with a repetition factor. For example, based on the RV codepoint of the DCI, the UE may determine the redundancy version to apply for decoding the RACH data transmission. The UE may also determine, based on the RV codepoint, the repetition factor to apply when transmitting the RACH transmission feedback.

In some examples, the linkage between the redundancy version and the repetition factor may depend on the transmission occasion of the RACH data transmission. For example, to improve the reliability of the UE receiving the RACH data transmission, the network entity may transmit repetitions (e.g., an initial transmission and at least one retransmission of the initial transmission) of the RACH data transmission. In some examples, the network entity may transmit a respective DCI scheduling each of the repetitions (e.g., a first DCI scheduling the initial transmission and at least a second DCI scheduling one retransmission of the initial transmission). In some such examples, aspects disclosed herein may link the redundancy version associated with the initial transmission of the RACH data transmission with the repetition factor for feedback for the initial transmission and use the same repetition for any retransmissions of the initial transmission. The UE may use the redundancy version in a subsequent DCI to facilitate decoding the respective retransmission and, thus, not link the redundancy version in subsequent DCI with a repetition factor. For example, the UE may use the redundancy version associated with a first DCI scheduling an initial transmission to determine a repetition factor to apply to the feedback for the initial transmission and for any retransmissions of the initial transmission. Thus, the UE may use the redundancy version associated with a second DCI scheduling a retransmission of the initial transmission to decode the retransmission of the initial transmission and not to determine a repetition factor to apply to the feedback for the retransmission of the initial transmission.

In some examples, the redundancy version associated with different transmissions may be included in a redundancy version pattern. The redundancy version pattern may be configured, e.g., by a system information block (SIB), or pre-configured at the UE, e.g., according to a technical specification. In some examples, if no additional information is provided by the network, e.g., if the network skips providing a redundancy version via the respective DCI(s) for transmitting and/or retransmitting a RACH data transmission, the UE applies the configured (or pre-configured) redundancy version pattern to decode the initial transmission of the RACH data transmission and the retransmissions of the initial transmission.

For example, a UE may be configured with a redundancy version pattern defined as RV0, RV2, RV3, RV1. In some other examples, the first DCI associated with the initial transmission may indicate a redundancy version for the initial transmission that is included in the redundancy version pattern. For example, the first DCI may indicate that the redundancy version for the initial transmission is RV2. In some such examples, the UE may associate a different redundancy version with a respective transmission occasion based on the configured (or pre-configured) redundancy version pattern. For example, based on the above redundancy version pattern and the redundancy version indicated by the first DCI (e.g., RV2), the UE may associate the RV2 with an initial transmission, the RV3 with a first retransmission of the initial transmission, the RV1 with a second retransmission of the initial transmission, and the RV0 with a third retransmission of the initial transmission. In some examples in which a redundancy version pattern is being employed (e.g., used), the network may skip providing a respective DCI scheduling any retransmissions of the initial transmission or may skip providing a redundancy version via the respective DCI. In some such examples, the UE may link the redundancy version indicated by the first DCI with a repetition factor for feedback for the initial transmission of the RACH data and for any subsequent retransmissions of the initial transmission. The UE may use the redundancy version pattern to determine the redundancy version to employ for decoding the retransmissions of the initial transmission.

In some aspects, the redundancy version pattern may be signaled or indicated by a first DCI associated with an initial transmission of the RACH data. For example, the first DCI may include a redundancy version pattern indicator to indicate which redundancy version pattern is being applied for the transmission occasions. In some aspects, the redundancy version pattern indicator may include an identifier (e.g., a redundancy version pattern index) of one or more configured (or pre-configured) redundancy version patterns. In some aspects, the redundancy version pattern indicator may define the pattern of redundancy versions being applied for the transmission occasions.

In some aspects, the UE receiving DCI associated with an initial transmission of the RACH data may use the rv Index indicated by the DCI to derive the repetition factor for the RACH transmission feedback. In some examples, the linkage between the repetition factor and the rv Index indicated by the DCI may be configured or pre-configured. In some examples, the linkage between the repetition factor and the rv Index indicated by the DCI may be signaled to the UE. For example, the linkage may be broadcast via a system information block (e.g., a SIB1) and/or may be configured via RRC signaling.

In some examples, the redundancy version to use for decoding the initial transmission of the RACH data transmission may be based on the rv Index indicated by the DCI. Thus, in some such examples, the rv Index indicated by the DCI may indicate to the UE the repetition factor for the RACH transmission feedback and the redundancy version to decode the initial transmission of the RACH data transmission. In other examples, the redundancy version to use for decoding the initial transmission of the RACH data transmission may be fixed (e.g., configured). In some such examples, the rv Index indicated by the DCI may indicate to the UE the repetition factor for the RACH transmission feedback and not the redundancy version to decode the initial transmission of the RACH data transmission.

Thus, it may be appreciated that the aspects presented herein enable indicating a repetition factor for a RACH transmission feedback without modifying the structure of the DCI corresponding to the initial transmission of the RACH data transmission. For example, aspects disclosed herein may re-use the rv Index to determine the repetition factor. In some such examples, the repetition factor may be indicated without adding a new information element to the DCI and, thus, without changing the size of the DCI. Applying a repetition factor to the RACH transmission feedback may improve communication performance, for example, by improving coverage and reliability associated with the msg4 feedback. Additionally, indicating the repetition factor via the rv Index may improve communication performance, for example, by avoiding adding a new information element to the DCI, which implies a change in size of the DCI and which increases overhead.

Although the following description provides examples directed to 5G NR, the concepts described herein may be applicable to other similar areas, such as 6G, 5G-advanced, LTE, LTE-A, CDMA, GSM, and/or other wireless technologies and/or future wireless technologies.

Although the following description provides examples directed to providing a repetition factor for RACH data transmissions (e.g., the msg4 PDSCH or the msgB PDSCH), the concepts described herein may be applicable to any message for which HARQ-ACK feedback is required and for which the repetition factor may be indicated via RRC signaling. For example, the concepts described herein facilitate dynamically indicating the repetition factor for the HARQ-ACK feedback without relying on RRC signaling. Thus, the repetition for the HARQ-ACK feedback may be determined before performing an RRC configuration procedure or an RRC reconfiguration procedure.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

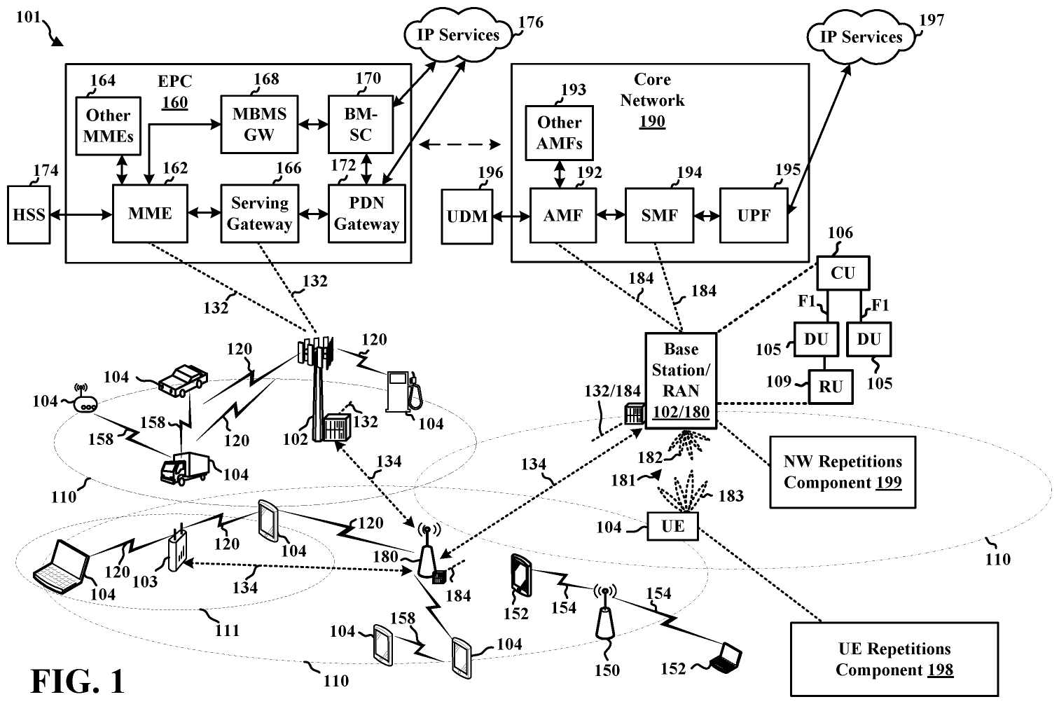

FIG. 1 is a diagram illustrating an example of a wireless communications system and an access network 101. The wireless communications system (also referred to as a wireless wide area network (WWAN)) includes base stations 102, UEs 104, an Evolved Packet Core (e.g., an EPC 160), and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., SI interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

In some aspects, a base station (e.g., one of the base stations 102 or one of base stations 180) may be referred to as a RAN and may include aggregated or disaggregated components. As an example of a disaggregated RAN, a base station may include a central unit (CU) (e.g., a CU 106), one or more distributed units (DU) (e.g., a DU 105), and/or one or more remote units (RU) (e.g., an RU 109), as illustrated in FIG. 1. A RAN may be disaggregated with a split between the RU 109 and an aggregated CU/DU. A RAN may be disaggregated with a split between the CU 106, the DU 105, and the RU 109. A RAN may be disaggregated with a split between the CU 106 and an aggregated DU/RU. The CU 106 and the one or more DUs may be connected via an F1 interface. A DU 105 and an RU 109 may be connected via a fronthaul interface. A connection between the CU 106 and a DU 105 may be referred to as a midhaul, and a connection between a DU 105 and the RU 109 may be referred to as a fronthaul. The connection between the CU 106 and the core network 190 may be referred to as the backhaul.

The RAN may be based on a functional split between various components of the RAN, e.g., between the CU 106, the DU 105, or the RU 109. The CU 106 may be configured to perform one or more aspects of a wireless communication protocol, e.g., handling one or more layers of a protocol stack, and the one or more DUs may be configured to handle other aspects of the wireless communication protocol, e.g., other layers of the protocol stack. In different implementations, the split between the layers handled by the CU and the layers handled by the DU may occur at different layers of a protocol stack. As one, non-limiting example, a DU 105 may provide a logical node to host a radio link control (RLC) layer, a medium access control (MAC) layer, and at least a portion of a physical (PHY) layer based on the functional split. An RU may provide a logical node configured to host at least a portion of the PHY layer and radio frequency (RF) processing. The CU 106 may host higher layer functions, e.g., above the RLC layer, such as a service data adaptation protocol (SDAP) layer, a packet data convergence protocol (PDCP) layer, and/or an upper layer. In other implementations, the split between the layer functions provided by the CU, the DU, or the RU may be different.

The base stations 102 may wirelessly communicate with the UEs 104. Each of the base stations 102 may provide communication coverage for a respective geographic coverage area 110. There may be overlapping geographic coverage areas. For example, a small cell 103 may have a coverage area 111 that overlaps the respective geographic coverage area 110 of one or more base stations (e.g., one or more macro base stations, such as the base stations 102). A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE to a base station and/or downlink (DL) (also referred to as forward link) transmissions from a base station to a UE. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs may communicate with each other using device-to-device (D2D) communication links, such as a D2D communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP), such as an AP 150, in communication with Wi-Fi stations (STAs), such as STAs 152, via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 103 may operate in a licensed and/or an unlicensed frequency spectrum. When operating in an unlicensed frequency spectrum, the small cell 103 may employ NR and use the same unlicensed frequency spectrum (e.g., 5 GHZ, or the like) as used by the Wi-Fi AP 150. The small cell 103, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

A base station, whether a small cell 103 or a large cell (e.g., a macro base station), may include and/or be referred to as an eNB, gNodeB (gNB), or another type of base station. Some base stations, such as a gNB, may operate in a traditional sub 6 GHz spectrum, in millimeter wave frequencies, and/or near millimeter wave frequencies in communication with the UEs 104. When the gNB operates in millimeter wave or near millimeter wave frequencies, the base stations 180 may be referred to as a millimeter wave base station. A millimeter wave base station may utilize beamforming 181 with the UEs 104 to compensate for the path loss and short range. The base stations 180 and the UEs 104 may each include a plurality of antennas, such as antenna elements, antenna panels, and/or antenna arrays to facilitate the beamforming.

The base stations 180 may transmit a beamformed signal to the UEs 104 in one or more transmit directions 182. The UEs 104 may receive the beamformed signal from the base stations 180 in one or more receive directions 183. The UEs 104 may also transmit a beamformed signal to the base stations 180 in one or more transmit directions. The base stations 180 may receive the beamformed signal from the UEs 104 in one or more receive directions. The base stations 180/UEs 104 may perform beam training to determine the best receive and transmit directions for each of the base stations 180/UEs 104. The transmit and receive directions for the base stations 180 may or may not be the same. The transmit and receive directions for the UEs 104 may or may not be the same.

The EPC 160 may include a Mobility Management Entity (e.g., an MME 162), other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway (e.g., a PDN Gateway 172). The MME 162 may be in communication with a Home Subscriber Server (HSS) (e.g., an HSS 174). The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) (e.g., an AMF 192), other AMFs 193, a Session Management Function (SMF) 194, and a User Plane Function (UPF) (e.g., a UPF 195). The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base stations 102 may include and/or be referred to as a gNB, Node B, eNB, an access point, a base transceiver station, a radio base station, a radio transceiver, a transceiver function, a basic service set (BSS), an extended service set (ESS), a transmission reception point (TRP), network node, network entity, network equipment, or some other suitable terminology. The base stations 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN). The base stations 102 provide an access point to the EPC 160 or core network 190 for the UEs 104.

Examples of UEs include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs may be referred to as IoT devices (e.g., parking meter, gas pump, toaster, vehicles, heart monitor, etc.). The UEs may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, a device in communication with a network entity, such as one of the UEs 104 in communication with one of the base stations 102 or a component of a base station (e.g., a CU 106, a DU 105, and/or an RU 109), may be configured to manage one or more aspects of wireless communication. For example, one of the UEs 104 may have a UE repetitions component 198 that may be configured to facilitate transmitting a quantity of repetitions of HARQ-ACK feedback for any message with associated HARQ-ACK feedback and before performing an RRC configuration procedure or an RRC reconfiguration procedure.

In certain aspects, the UE repetitions component 198 may be configured to receive, before a RRC configuration procedure or an RRC reconfiguration procedure, a first communication scheduling a first data transmission with associated feedback. The first communication may include first information associated with the first data transmission and a first rv Index. The example UE repetitions component 198 may also be configured to attempt to receive the first data transmission based on the first information. Additionally, the example UE repetitions component 198 may be configured to transmit, based on the first rv Index, a first quantity of repetitions of first data feedback for the first data transmission.

In another configuration, a network entity, such as one of the base stations 102 or a component of a base station (e.g., a CU 106, a DU 105, and/or an RU 109), may be configured to manage or more aspects of wireless communication. For example, one of the base stations 102 may have a NW repetitions component 199 that may be configured to facilitate indicating a quantity of repetitions of HARQ-ACK feedback for any message with associated HARQ-ACK feedback and before performing an RRC configuration procedure or an RRC reconfiguration procedure.

In certain aspects, the NW repetitions component 199 may be configured to output, before a RRC configuration procedure or an RRC reconfiguration procedure, a first communication scheduling a first data transmission with associated feedback. The first communication may include first information associated with the first data transmission and a first rv Index. The example NW repetitions component 199 may also be configured to output the first data transmission based on the first information. Additionally, the example NW repetitions component 199 may be configured to obtain, based on the first rv Index, a first quantity of repetitions of first data feedback for the first data transmission.

Aspects presented herein enable indicating a repetition factor for msg4 feedback or msgB feedback without modifying the structure of the DCI corresponding to an initial transmission of msg4 PDSCH or msgB PDSCH, respectively. For example, aspects disclosed herein may re-use the rv Index to determine the repetition factor. In some such examples, the repetition factor may be indicated without adding a new information element to the first DCI and, thus, without changing the size of the first DCI.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

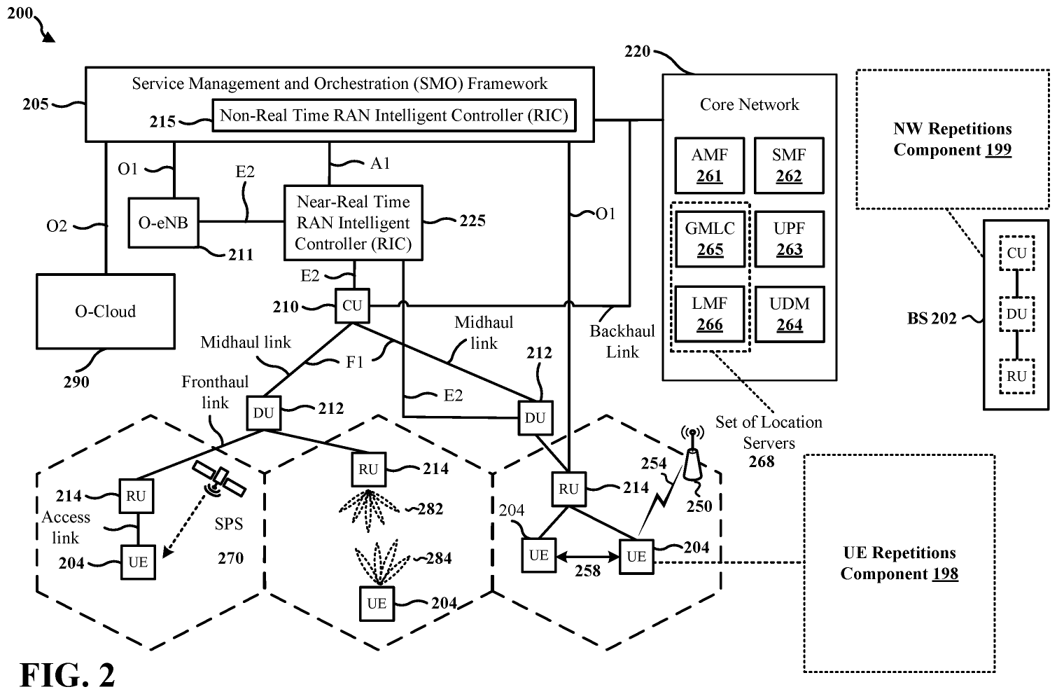

As an example, FIG. 2 shows a diagram illustrating architecture of an example of a disaggregated base station 200. The architecture of the disaggregated base station 200 may include one or more CUs (e.g., a CU 210) that can communicate directly with a core network 220 via a backhaul link, or indirectly with the core network 220 through one or more disaggregated base station units (such as a Near-Real Time (Near-RT) RAN Intelligent Controller (RIC) (e.g., a Near-RT RIC 225) via an E2 link, or a Non-Real Time (Non-RT) RIC 215 associated with a Service Management and Orchestration (SMO) Framework (e.g., an SMO Framework 205), or both). A CU 210 may communicate with one or more DUs (e.g., a DU 212) via respective midhaul links, such as an F1 interface. The DU 212 may communicate with one or more RUs (e.g., an RU 214) via respective fronthaul links. The RU 214 may communicate with respective UEs (e.g., a UE 204) via one or more radio frequency (RF) access links. In some implementations, the UE 204 may be simultaneously served by multiple RUS. Each of the units, i.e., the CUS (e.g., a CU 210), the DUs (e.g., a DU 212), the RUs (e.g., an RU 214), as well as the Near-RT RICs (e.g., the Near-RT RIC 225), the Non-RT RICs (e.g., the Non-RT RIC 215), and the SMO Framework 205, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as an E1 interface when implemented in an O-RAN configuration. The CU 210 can be implemented to communicate with the DU 212, as necessary, for network control and signaling.

The DU 212 may correspond to a logical unit that includes one or more base station functions to control the operation of one or more RUs. In some aspects, the DU 212 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 212 may further host one or more low PHY layers. Each layer (or module) can be implemented with an interface configured to communicate signals with other layers (and modules) hosted by the DU 212, or with the control functions hosted by the CU 210.

Lower-layer functionality can be implemented by one or more RUs. In some deployments, an RU 214, controlled by a DU 212, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU 214 can be implemented to handle over the air (OTA) communication with one or more UEs (e.g., the UE 204). In some implementations, real-time and non-real-time aspects of control and user plane communication with the RU 214 can be controlled by a corresponding DU. In some scenarios, this configuration can enable the DU(s) and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements that may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs, DUs, RUS and Near-RT RICs. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs, one or more DUs, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

At least one of the CU 210, the DU 212, and the RU 214 may be referred to as a base station 202. Accordingly, a base station 202 may include one or more of the CU 210, the DU 212, and the RU 214 (each component indicated with dotted lines to signify that each component may or may not be included in the base station 202). The base station 202 provides an access point to the core network 220 for a UE 204. The communication links between the RUs (e.g., the RU 214) and the UEs (e.g., the UE 204) may include uplink (UL) (also referred to as reverse link) transmissions from a UE 204 to an RU 214 and/or downlink (DL) (also referred to as forward link) transmissions from an RU 214 to a UE 204.

Certain UEs may communicate with each other using D2D communication (e.g., a D2D communication link 258). The D2D communication link 258 may use the DL/UL WWAN spectrum. The D2D communication link 258 may use one or more sidelink channels. D2D communication may be through a variety of wireless D2D communications systems, such as for example, Bluetooth, Wi-Fi based on the IEEE 802.11 standard, LTE, or NR.

The wireless communications system may further include a Wi-Fi AP 250 in communication with a UE 204 (also referred to as Wi-Fi STAs) via communication link 254, e.g., in a 5 GHz unlicensed frequency spectrum or the like. When communicating in an unlicensed frequency spectrum, the UE 204/Wi-Fi AP 250 may perform a CCA prior to communicating in order to determine whether the channel is available.

The base station 202 and the UE 204 may each include a plurality of antennas, such as antenna elements, antenna panels, and/or antenna arrays to facilitate beamforming. The base station 202 may transmit a beamformed signal 282 to the UE 204 in one or more transmit directions. The UE 204 may receive the beamformed signal from the base station 202 in one or more receive directions. The UE 204 may also transmit a beamformed signal 284 to the base station 202 in one or more transmit directions. The base station 202 may receive the beamformed signal from the UE 204 in one or more receive directions. The base station 202/UE 204 may perform beam training to determine the best receive and transmit directions for each of the base station 202/UE 204. The transmit and receive directions for the base station 202 may or may not be the same. The transmit and receive directions for the UE 204 may or may not be the same.

The core network 220 may include an Access and Mobility Management Function (AMF) (e.g., an AMF 261), a Session Management Function (SMF) (e.g., an SMF 262), a User Plane Function (UPF) (e.g., a UPF 263), a Unified Data Management (UDM) (e.g., a UDM 264), one or more location servers 268, and other functional entities. The AMF 261 is the control node that processes the signaling between the UE 204 and the core network 220. The AMF 261 supports registration management, connection management, mobility management, and other functions. The SMF 262 supports session management and other functions. The UPF 263 supports packet routing, packet forwarding, and other functions. The UDM 264 supports the generation of authentication and key agreement (AKA) credentials, user identification handling, access authorization, and subscription management. The one or more location servers 268 are illustrated as including a Gateway Mobile Location Center (GMLC) (e.g., a GMLC 265) and a Location Management Function (LMF) (e.g., an LMF 266). However, generally, the one or more location servers 268 may include one or more location/positioning servers, which may include one or more of the GMLC 265, the LMF 266, a position determination entity (PDE), a serving mobile location center (SMLC), a mobile positioning center (MPC), or the like. The GMLC 265 and the LMF 266 support UE location services. The GMLC 265 provides an interface for clients/applications (e.g., emergency services) for accessing UE positioning information. The LMF 266 receives measurements and assistance information from the NG-RAN and the UE 204 via the AMF 261 to compute the position of the UE 204. The NG-RAN may utilize one or more positioning methods in order to determine the position of the UE 204. Positioning the UE 204 may involve signal measurements, a position estimate, and an optional velocity computation based on the measurements. The signal measurements may be made by the UE 204 and/or the base station 202 serving the UE 204. The signals measured may be based on one or more of a satellite positioning system (SPS) 270 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

A wireless device, such as the UE 204, may include the UE repetitions component 198 that may be configured to facilitate transmitting a quantity of repetitions of Msg4 HARQ-ACK feedback or MsgB HARQ-ACK feedback, as described in connection with the example of FIG. 1.

In certain aspects, a network entity, such as the disaggregated base station 200, or a component of the base station, may include the NW repetitions component 199 that may be configured to facilitate indicating a quantity of repetitions of Msg4 HARQ-ACK feedback or MsgB HARQ-ACK feedback, as described in connection with the example of FIG. 1.

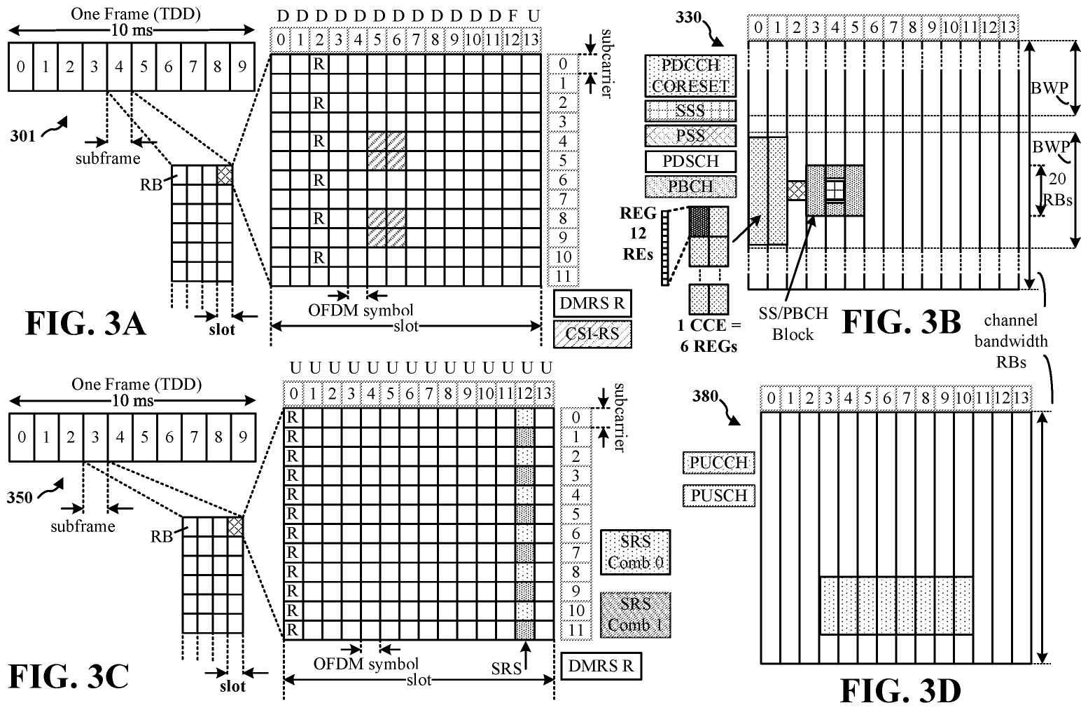

FIG. 3A is a diagram 301 illustrating an example of a first subframe within a 5G NR frame structure. FIG. 3B is a diagram 330 illustrating an example of DL channels within a 5G NR subframe. FIG. 3C is a diagram 350 illustrating an example of a second subframe within a 5G NR frame structure. FIG. 3D is a diagram 380 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 3A, 3C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 3A-3D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. As shown in Table 1, the subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 3A-3D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 3B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

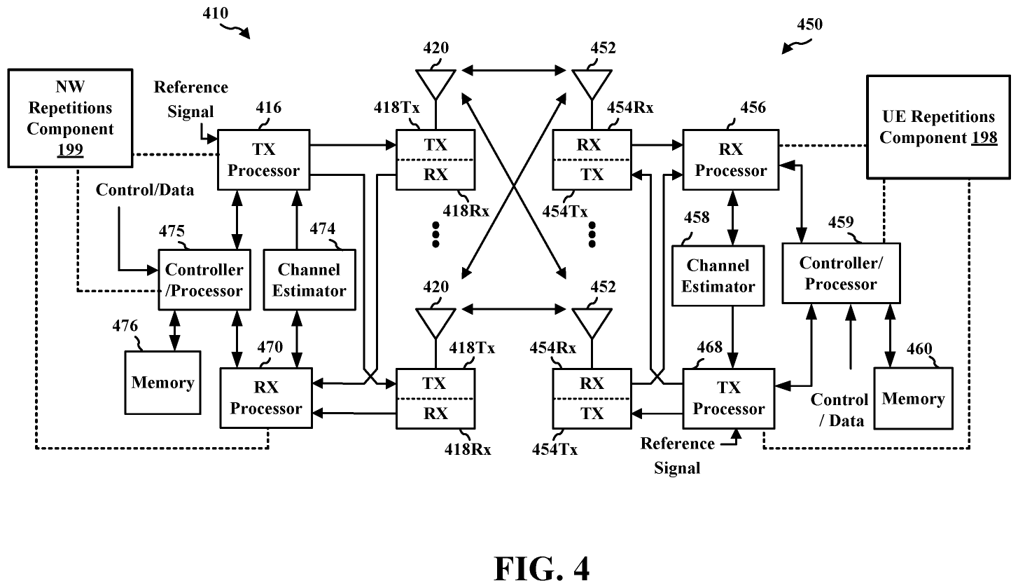

FIG. 4 is a block diagram that illustrates an example of a first wireless device that is configured to exchange wireless communication with a second wireless device. In the illustrated example of FIG. 4, the first wireless device may include a base station 410, the second wireless device may include a UE 450, and the base station 410 may be in communication with the UE 450 in an access network. As shown in FIG. 4, the base station 410 includes a transmit processor (TX processor 416), a transmitter 418Tx, a receiver 418Rx, antennas 420, a receive processor (RX processor 470), a channel estimator 474, a controller/processor 475, and memory 476. The example UE 450 includes antennas 452, a transmitter 454Tx, a receiver 454Rx, an RX processor 456, a channel estimator 458, a controller/processor 459, memory 460, and a TX processor 468. In other examples, the base station 410 and/or the UE 450 may include additional or alternative components.

In the DL, Internet protocol (IP) packets may be provided to the controller/processor 475. The controller/processor 475 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 475 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The TX processor 416 and the RX processor 470 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 416 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from the channel estimator 474 may be used to determine the coding and modulation scheme, as well as for spatial processing. The channel estimate may be derived from a reference signal and/or channel condition feedback transmitted by the UE 450. Each spatial stream may then be provided to a different antenna of the antennas 420 via a separate transmitter (e.g., the transmitter 418Tx). Each transmitter 418Tx may modulate a radio frequency (RF) carrier with a respective spatial stream for transmission.

At the UE 450, each receiver 454Rx receives a signal through its respective antenna of the antennas 452. Each receiver 454Rx recovers information modulated onto an RF carrier and provides the information to the RX processor 456. The TX processor 468 and the RX processor 456 implement layer 1 functionality associated with various signal processing functions. The RX processor 456 may perform spatial processing on the information to recover any spatial streams destined for the UE 450. If multiple spatial streams are destined for the UE 450, two or more of the multiple spatial streams may be combined by the RX processor 456 into a single OFDM symbol stream. The RX processor 456 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 410. These soft decisions may be based on channel estimates computed by the channel estimator 458. The soft decisions are then decoded and deinterleaved to recover the data and control signals that were originally transmitted by the base station 410 on the physical channel. The data and control signals are then provided to the controller/processor 459, which implements layer 3 and layer 2 functionality.

The controller/processor 459 can be associated with the memory 460 that stores program codes and data. The memory 460 may be referred to as a computer-readable medium. In the UL, the controller/processor 459 provides demultiplexing between transport and logical channels, packet reassembly, deciphering, header decompression, and control signal processing to recover IP packets. The controller/processor 459 is also responsible for error detection using an ACK and/or NACK protocol to support HARQ operations.

Similar to the functionality described in connection with the DL transmission by the base station 410, the controller/processor 459 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by the channel estimator 458 from a reference signal or feedback transmitted by the base station 410 may be used by the TX processor 468 to select the appropriate coding and modulation schemes, and to facilitate spatial processing. The spatial streams generated by the TX processor 468 may be provided to different antenna of the antennas 452 via separate transmitters (e.g., the transmitter 454Tx). Each transmitter 454Tx may modulate an RF carrier with a respective spatial stream for transmission.

The UL transmission is processed at the base station 410 in a manner similar to that described in connection with the receiver function at the UE 450. Each receiver 418Rx receives a signal through its respective antenna of the antennas 420. Each receiver 418Rx recovers information modulated onto an RF carrier and provides the information to the RX processor 470.

The controller/processor 475 can be associated with the memory 476 that stores program codes and data. The memory 476 may be referred to as a computer-readable medium. In the UL, the controller/processor 475 provides demultiplexing between transport and logical channels, packet reassembly, deciphering, header decompression, control signal processing to recover IP packets. The controller/processor 475 is also responsible for error detection using an ACK and/or NACK protocol to support HARQ operations.

At least one of the TX processor 468, the RX processor 456, and the controller/processor 459 may be configured to perform aspects in connection with the UE repetitions component 198 of FIG. 1.

At least one of the TX processor 416, the RX processor 470, and the controller/processor 475 may be configured to perform aspects in connection with the NW repetitions component 199 of FIG. 1.

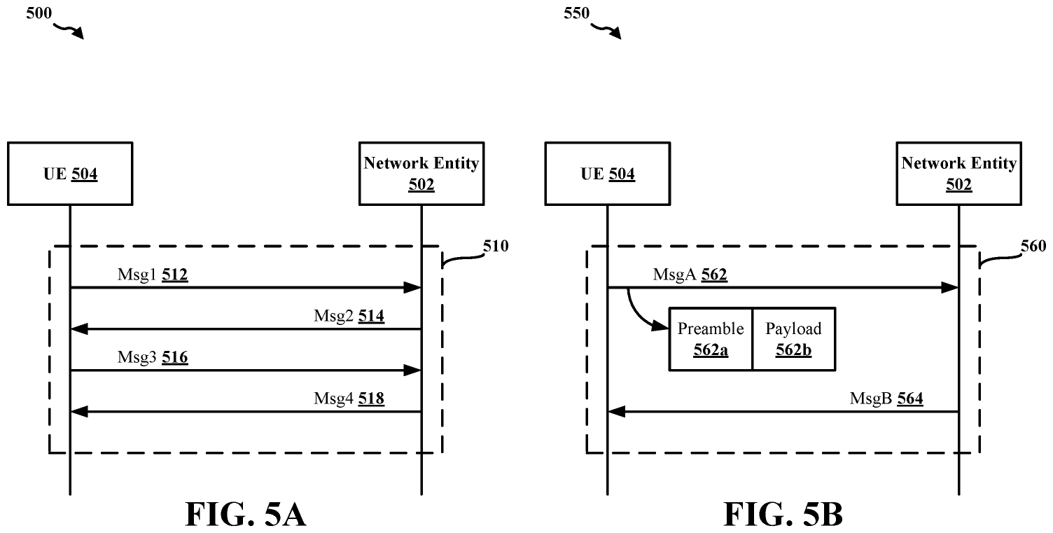

FIG. 5A is a diagram illustrating a communication flow 500 between a network entity 502 and a UE 504 implementing a four-step RACH procedure 510. In the illustrated example of FIG. 5A, the four-step RACH procedure 510 includes the exchange of four messages. Specifically, the UE 504 may initiate the message exchange of the four-step RACH procedure 510 by sending, to the network entity 502, a first four-step RACH transmission (e.g., a msg1 512) including a preamble (e.g., without a payload). The network entity 502 then sends, to the UE 504, a second four-step RACH transmission (e.g., a msg2 514) including a random access response (RAR). In some aspects, the msg2 514 may include an identifier of the RACH preamble, a timing advance (TA), an uplink grant for the UE 504 to transmit data, cell radio network temporary identifier (C-RNTI), and/or a back-off indicator. The UE 504 then sends a third four-step RACH transmission (e.g., a msg3 516) to the network entity 502. In some aspects, the msg3 516 may include an RRC connection request, an RRC connection re-establishment request, or an RRC connection resume request, depending on the trigger for the UE 504 initiating the random access procedure. The network entity 502 then completes the four-step RACH procedure 510 by sending a fourth four-step RACH transmission (e.g., a msg4 518) to the UE 504. In some aspects, the msg4 518 includes timing advancement information, contention resolution information, and/or RRC connection setup information.

FIG. 5B is a diagram illustrating a communication flow 550 between the network entity 502 and the UE 504 implementing a two-step RACH procedure 560. In the illustrated example of FIG. 5B, the two-step RACH procedure 560 includes the exchange of two messages. Specifically, the UE 504 may initiate the message exchange of the two-step RACH procedure 560 by sending a first two-step RACH transmission (e.g., a msgA 562) to the network entity 502. Responsive to the msgA 562, the network entity 502 may complete the message exchange of the two-step RACH procedure 560 by sending a second two-step RACH transmission (e.g., a msgB 564) to the UE 504.

In some aspects, to initiate the two-step RACH procedure 560, the UE 504 may generate the msgA 562. For the two-step RACH procedure 560, the UE 504 may generate the msgA 562 to include at least a preamble 562a (e.g., a PRACH preamble) and a payload 562b. In some aspects, the preamble 562a may correspond to the msg1 512 and the payload 562b may correspond to the msg3 516 of the four-step RACH procedure 510 of FIG. 5A.

The UE 504 may be identified by the network entity 502 according to an identifier (ID) of the UE 504, such as a radio network temporary identifier (RNTI) (e.g., a random access (RA) RNTI, a temporary RNTI, etc.). The msgA 562 may be the first transmission by the UE 504 to the network entity 502 and, therefore, the network entity 502 may benefit from a mechanism for indicating the ID of the UE 504 to the network entity 502 in the msgA 562, particularly because the msgA 562 may include data from the UE 504 in the payload 562b. Accordingly, the UE 504 may indicate an ID of the UE 504 using one or more (or a combination of) approaches for including information in the msgA 562.

In response to receiving the msgA 562, the network entity 502 may generate the msgB 564. The network entity 502 may generate the msgB 564 to include control information in a PDCCH and data in a PDSCH. The network entity 502 may send the msgB 564 to the UE 504 to complete the two-step RACH procedure 560. In some aspects, information included in the msgB 564 may correspond to the msg2 514 and the msg4 518 of the four-step RACH procedure 510 of FIG. 5A. The UE 504 may receive the msgB 564, and the UE 504 may acquire timing synchronization based on the msgB 564.

While the two-step RACH procedure 560 of FIG. 5B differs in some aspects from the four-step RACH procedure 510 of FIG. 5A, some aspects may be common across the RACH procedures. For example, sequences associated with a physical RACH (PRACH) and sequences associated with DMRS used for the four-step RACH procedure 510 may also be used for the two-step RACH procedure 560.

In some examples, the UE may be configured to transmit feedback (e.g., an ACK or a NACK) for a RACH transmission. For example, the UE may be configured to transmit HARQ-ACK feedback for a RACH transmission. In some examples, the UE may be configured to transmit feedback for a last RACH transmission of a RACH procedure (e.g., the msg4 518 of FIG. 5A or the msgB 564 of FIG. 5B). The feedback may indicate to the network entity whether the RACH procedure is complete.

In some such examples, the UE may receive a configuration indicating one or more resources to use when transmitting the feedback. For example, the UE may receive a PUCCH resource configuration for transmitting the feedback for the last RACH transmission. The PUCCH resource configuration may be indicated via system information. For example, the UE may receive a system information block (e.g., a SIB1) that indicates the PUCCH resource configuration. The PUCCH resource configuration may be included in an information element (IE) of the system information block, such as a PICCH-ConfigCommon IE.

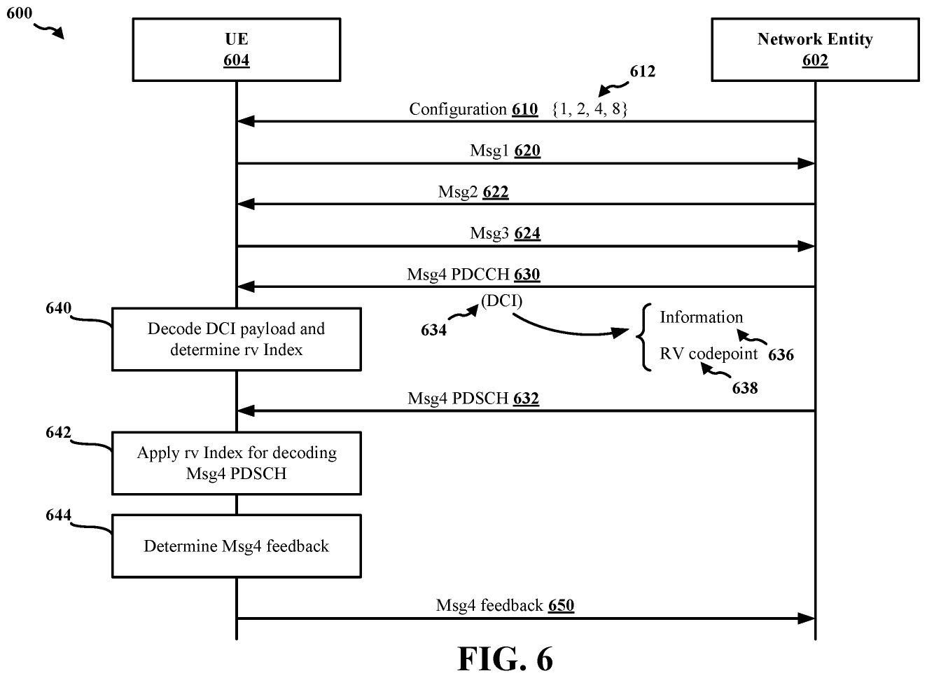

FIG. 6 illustrates an example communication flow 600 between a network entity 602 and a UE 604, as presented herein. One or more aspects described for the network entity 602 may be performed by a component of a base station or a network entity, such as a CU, a DU, and/or an RU. In the illustrated example, the communication flow 600 facilitates the UE 604 providing feedback for a last transmission of a RACH procedure. Although the example of FIG. 6 illustrates aspects of a four-step RACH procedure, such as the four-step RACH procedure 510 of FIG. 5A, in other examples, the techniques may be applied to a two-step RACH procedure.

Aspects of the network entity 602 may be implemented by one of the base stations 102 of FIG. 1 and/or the base station 410 of FIG. 4. Aspects of the UE 604 may be implemented by one of the UEs 104 of FIG. 1 and/or the UE 450 of FIG. 4. Although not shown in the illustrated example of FIG. 6, it may be appreciated that in additional or alternative examples, the network entity 602 and/or the UE 604 may be in communication with one or more other base stations or UEs.

In the illustrated example of FIG. 6, the network entity 602 transmits (e.g., outputs) a configuration 610 that is received (e.g., obtained) by the UE 604. The configuration 610 may be provided via system information, such as a SIB1. In the example of FIG. 6, the configuration 610 includes a PUCCH resource configuration that configures one or more PUCCH resources for the UE 604 to use when providing feedback. The configuration 610 may be referred to as a PIC(H-ConfigCommon IE or by any other name.

As shown in the example of FIG. 6, the network entity 602 and the UE 604 may exchange messages associated with a four-step RACH procedure. For example, the UE 604 may transmit a first message 620 that is received by the network entity 602. The network entity 602 may transmit a second message 622 that is received by the UE 604. The UE 604 may transmit a third message 624 that is received by the network entity 602. Aspects of the first message 620, the second message 622, and the third message 624 may be similar to the msg1 512, the msg2 514, and the msg3 516, respectively, of FIG. 5A.

In some examples, the ability of the UE to successfully receive a message depends on the ability of the UE to receive control information (e.g., via a PDCCH resource) and data (e.g., via a PDSCH resource). For example, the ability of the UE 604 to successfully receive a msg4 of a four-step RACH procedure may depend on the ability of the UE 604 to receive msg4 PDCCH and msg4 PDSCH.

In the illustrated example of FIG. 6, the network entity 602 transmits msg4 PDCCH 630 that is received by the UE 604. The msg4 PDCCH 630 may carry DCI 634 scheduling msg4 PDSCH 632. In some examples, the DCI 634 may be implemented by a DCI format 1_0. In the example of FIG. 6, the msg4 PDCCH 630 schedules msg4 PDSCH 632. For example, the msg4 PDCCH 630 includes information 636 (e.g., frequency resources and/or time resources) to facilitate receiving the msg4 PDSCH 632.

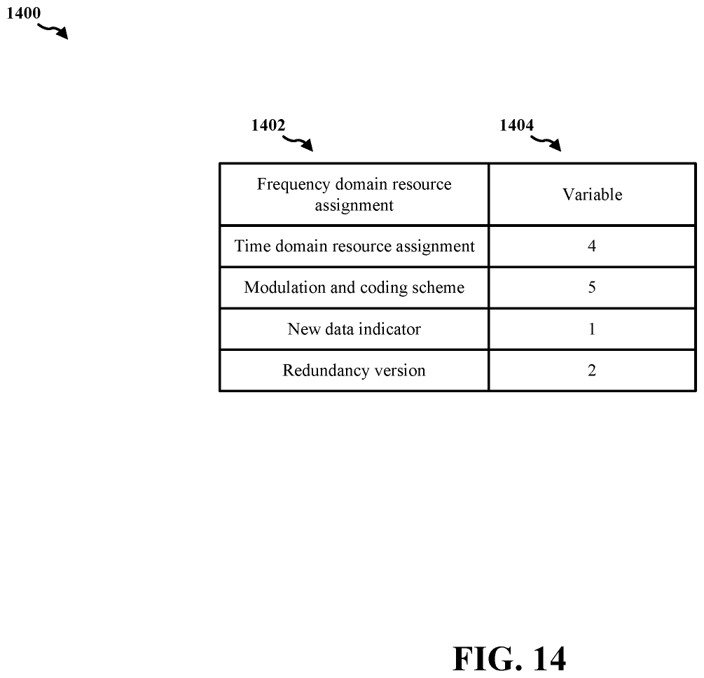

FIG. 14 is a diagram illustrating example fields of a DCI 1400 that may schedule a data transmission with associated feedback, as presented herein. For example, the DCI 1400 may correspond to the example DCI 634 of FIG. 6 and the data transmission may correspond to the example msg4 PDSCH 632 of FIG. 6. The information included in the example fields may facilitate receiving the data transmission. In the illustrated example of FIG. 14, a first column 1402 indicates a field of the DCI 1400 and a second column 1404 indicates a quantity of bits allocated for the respective field. For example, the DCI 1400 may include a frequency domain resource assignment (FDRA) field with a variable number of bits. The DCI 1400 may include 4-bits allocated to a time domain resource assignment (TDRA) field. The FDRA field and the TDRA field may point to frequency domain resources (e.g., sub-channels) and time domain resources (e.g., slots) associated with the data transmission. The DCI 1400 may include 5-bits allocated to a modulation and coding scheme (MCS) field. The MCS field may indicate the coding and modulation scheme (e.g., BPSK, QPSK, M-PSK, M-QAM, etc.) applied to the data transmission and, thus, what scheme to select to demodulate the data transmission. The DCI 1400 may include 1-bit allocated to a new data indicator (NDI) field. The NDI field may indicate whether the data transmission is a new transmission (e.g., an initial transmission) or a retransmission. The DCI 1400 may include 2-bits allocated to a redundancy version field. The redundancy version field may indicate the redundancy version applied to the data transmission.

It may be appreciated that the fields shown in FIG. 14 are example fields that may be included in DCI and that other examples may include additional or alternate fields.

Referring again to the example of FIG. 6, the msg4 PDCCH 630 also includes an RV codepoint 638. The RV codepoint 638 may be included in a field (e.g., a “redundancy version” field) of the msg4 PDCCH 630. In some examples, the size of the RV codepoint 638 may be 2-bits, as shown in the example DCI 1400 of FIG. 14.

The RV codepoint 638 may indicate a redundancy version to be applied to a corresponding PDSCH transmission. The redundancy version may also be referred to as an “rv Index,” an “RV identifier,” or an “RVID.” In some examples, a network entity may use redundancy version cycling to transmit a different set of encoded bits in different PDSCH transmissions. A UE receiving the PDSCH transmission may use the redundancy version to decode the PDSCH transmission. For example, the network entity 602 may use a redundancy version to encode the msg4 PDSCH 632. The network entity 602 may then transmit the RV codepoint 638 that maps to the redundancy version. The network entity 602 may transmit the RV codepoint 638 in the DCI 634 scheduling the msg4 PDSCH 632.

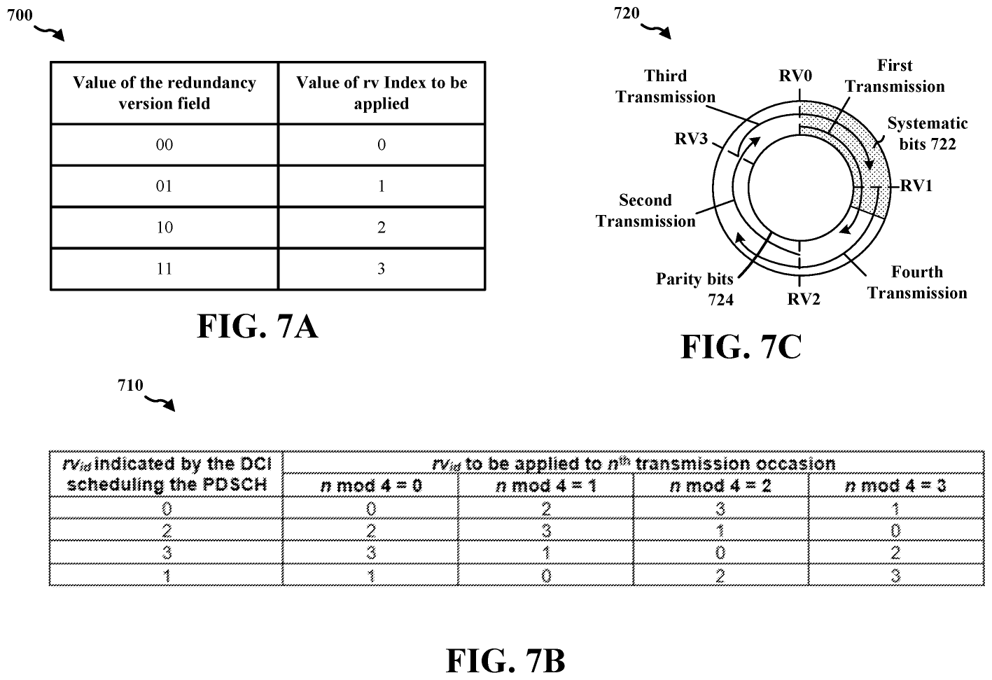

FIG. 7A is a diagram illustrating an example of redundancy version cycling based on PDSCH transmission occasions, as presented herein. In the illustrated example of FIG. 7A, a table 700 illustrates a mapping between a value of a redundancy version field (e.g., the RV codepoint 638 of FIG. 6) and a value of an rv Index rv_{id} to be applied. For example, referring to the table 700, a codepoint of the redundancy version field may be “00,” which maps to the rv Index of “0” (e.g., rv_{id}=0 or RV0).

A UE may then use the redundancy version to apply to a PDSCH transmission. For example, FIG. 7B is a diagram illustrating an example table 710 associated with redundancy version cycling, as presented herein. As shown by the table 710, if the network entity indicates an rv Index of “0,” then the UE may determine a redundancy version to be applied to an nth transmission occasion by calculating n mod 4, where “mod” represents a modulo operation. As an example, if n mod 4=0 (e.g., for a transmission occasion 0, which may also be referred to as a “new” transmission or an “initial” transmission), then the UE applies RV0 to that transmission occasion. If n mod 4=1 (e.g., for a transmission occasion 1), then the UE applies RV2 to that transmission occasion. If n mod 4=2 (e.g., for a transmission occasion 2), then the UE applies RV3 to that transmission occasion. If n mod 4=3 (e.g., for a transmission occasion 3), then the UE applies RV1 to that transmission occasion. As shown in the table 710, the redundancy version may have a value of 0, 1, 2, or 3, each of which corresponds to a different sequence of redundancy versions (e.g., a different order for RV0, RV1, RV2, and RV3).

In some examples, the redundancy version of an initial transmission may be fixed to zero (e.g., RV0). Additionally, in some examples, using a redundancy version different than RV0 for the initial transmission may provide no gain or limited gain. In any case, a network may select a self-decodable redundancy version for the initial transmission. A self-decodable redundancy version is a redundancy version that, assuming perfect channel conditions, allows the UE to successfully decode a transmission.

The redundancy version may indicate a starting location in a circular buffer. For example, FIG. 7C is a diagram illustrating an example circular buffer 720, as presented herein. Using redundancy version cycling, the network entity may transmit a different set of (e.g., one or more) encoded bits in different PDSCH repetitions. For example, the network entity may store bits for a downlink transmission in the circular buffer 720 (e.g., stored in a memory accessible to the network entity). The circular buffer 720 stores systematic bits 722 (sometimes called “information” bits) and parity bits 724 (sometimes called “parity-check” bits). The stores systematic bits 722 may include the data to be transmitted, and the parity bits 724 may include linear combinations of the data (e.g., the stores systematic bits 722). The network entity may encode the stores systematic bits 722, the parity bits 724, or a combination of the stores systematic bits 722 and the parity bits 724 into a set of encoded bits and may transmit the set of encoded bits for a PDSCH repetition. The particular bits that are selected to be included in the set of encoded bits for a PDSCH repetition depend on (or are defined by) the redundancy version of that PDSCH repetition. By selecting different combinations of the stores systematic bits 722 and the parity bits 724, the network entity may improve reliability of PDSCH transmissions, since not all bit positions are associated with the same level of reliability.

Referring again to the example of FIG. 6, after receiving the DCI 634, the UE 604 may perform a decoding procedure 640 to decode the DCI payload (e.g., the information 636 and the RV codepoint 638) and determine the value of the rv Index.

In the illustrated example of FIG. 6, the network entity 602 may transmit the msg4 PDSCH 632 that is received by the network entity 602. The UE 604 may perform an applying procedure 642 to apply the redundancy version for decoding the msg4 PDSCH 632. For example, using the examples of FIG. 7A, FIG. 7B, and FIG. 7C, the UE 604 may map the RV codepoint 638 to an rv Index (rv_{id}). The UE 604 may then apply the redundancy version to decode the msg4 PDSCH 632.

In the illustrated example of FIG. 6, the UE 604 may perform a feedback procedure 644 to determine feedback for the msg4. For example, the UE 604 may determine an ACK when the UE 604 successfully receives the msg4. The UE 604 may determine a NACK when the UE 604 is unsuccessful in receiving the msg4. As shown in FIG. 6, the UE 604 outputs a msg4 feedback 650 that is received by the network entity 602. The UE 604 may use the PUCCH resources configured by the configuration 610 to transmit the msg4 feedback 650.

In some examples, the network entity 602 may use the msg4 feedback 650 to determine whether the RACH procedure was successful or unsuccessful. However, in some cases, the msg4 feedback 650 may be missed by the network entity 602 or may be incorrectly decoded by the network entity 602. Thus, the network entity 602 and the UE 604 may use repetitions to improve reliability. Repetition may improve reliability because repetitions increase the probability of successful reception of a transmission, such as the msg4 feedback 650.

As used herein, the term “repetition” refers to the initial transmission and is also used to refer to a repeated transmission of the initial transmission. For example, if a UE is configured to transmit four repetitions, then the UE may transmit an initial transmission and may transmit three repeated transmissions of that initial transmission.

In some examples, the UE 604 may be configured with a set of repetition factors associated with the msg4 feedback 650. The set of repetition factors may include at least two repetition factors. For example, the configuration 610 may configure a set of repetition factors 612 at the UE 604. In the illustrated example of FIG. 6, the set of repetition factors 612 includes four repetition factors (e.g., 1, 2, 4, and 8).

Aspects disclosed herein facilitate a network entity indicating a repetition factor for a UE to apply to the feedback for a last transmission of a RACH procedure (e.g., the msg4 or the msgB) when the UE is configured with multiple repetition factors. For example, the network entity may indicate the repetition factor to apply dynamically via DCI, such as the DCI 634. Additionally, aspects disclosed herein facilitate indicating the repetition factor to apply without impacting the size of the DCI. For example, the network entity may indicate the repetition factor without adding a new information element. That is, the network entity may indicate the repetition factor using the fields that are already included in the DCI, such as the DCI 634.

Aspects disclosed herein facilitate linking the rv Index indicated by the DCI scheduling the msg4 PDSCH with a repetition factor. For example, based on the codepoint of the redundancy version field of the DCI, the UE may determine the redundancy version to apply for decoding the msg4 PDSCH. The UE may also determine, based on the codepoint of the redundancy version field of the DCI, the repetition factor (e.g., a quantity of repetitions) to apply when transmitting the msg4 feedback.

In some examples, the linkage between the rv Index and the repetition factor may depend on the transmission occasion of the msg4 PDSCH. For example, to improve the reliability of the UE receiving the msg4 PDSCH, the network entity may transmit repetitions (e.g., an initial transmission and at least one retransmission of the initial transmission) of the msg4 PDSCH. In some examples, the network entity may transmit a respective DCI scheduling each of the transmission occasions. For example, a first DCI may schedule an initial transmission, a second DCI may schedule a retransmission of the initial transmission, etc. In some such examples, aspects disclosed herein may link the rv Index associated with the initial transmission with the repetition factor for the msg4 feedback and use the rv Index in subsequent DCI to facilitate decoding the respective retransmission. Additionally, the UE may use the same repetition factor for the msg4 feedback for each retransmission (if any) of the msg4 PDSCH. For example, the UE may store (e.g., in a buffer) the repetition factor or the rv Index associated with the msg4 feedback for the initial transmission of the msg4 PDSCH and use the same repetition factor for the msg4 feedback for each retransmission of the msg4 PDSCH.

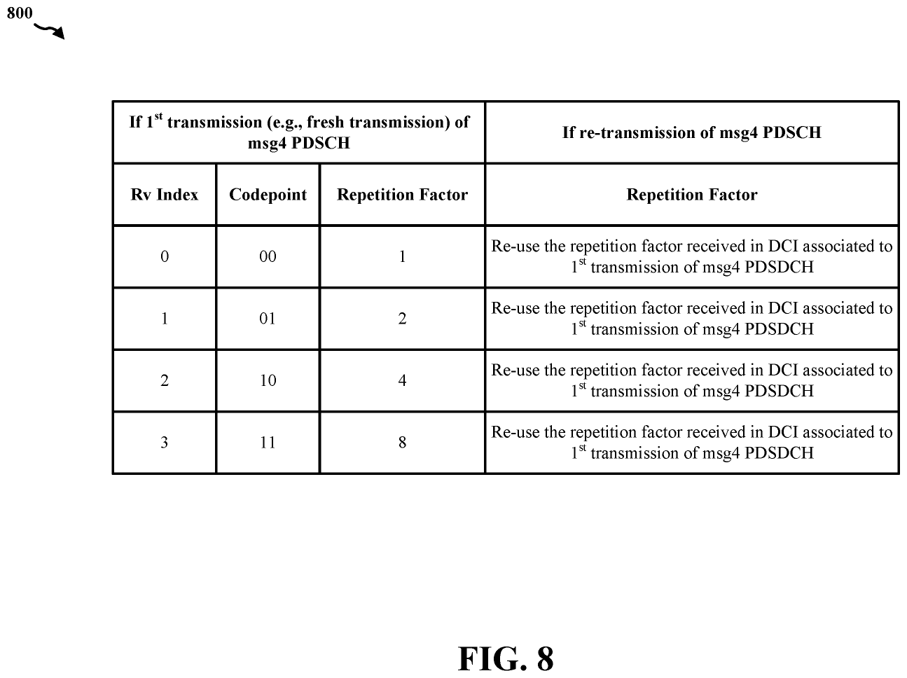

FIG. 8 is a diagram of a table 800 illustrating linking between a codepoint, an rv Index, and a repetition factor, as presented herein. In some examples, the UE may be configured (or pre-configured) with the linking between the codepoint, the rv Index, and the repetition factor. In some examples, the network may signal the linkage between the codepoint, the rv Index, and the repetition factor. For example, the linkage may be broadcast via a system information block (e.g., a SIB1) and/or may be configured via RRC signaling.

As shown in the example table 800, the repetition factor for msg4 feedback is based on the rv Index associated with the initial transmission of the msg4 PDSCH. For example, a network entity may indicate to a UE that the network entity is sending four repetitions of a msg4 PDSCH (e.g., an initial transmission and three retransmissions of the initial transmission). In some such examples, the network entity may output a first DCI scheduling the initial transmission. The network entity may also output a second DCI scheduling a first retransmission of the initial transmission, a third DCI scheduling a second retransmission of the initial transmission, and a fourth DCI scheduling a third retransmission of the initial transmission. Each of the four DCIs may indicate an rv Index (e.g., via their respective redundancy version fields) associated with their respective msg4 PDSCH transmission. However, the UE may use the value of the rv Index of the first DCI to determine the repetition factor to use for the msg4 feedback and disregard the rv Index in the subsequent DCI for determining the repetition factor.

As an example, the network entity may indicate it is outputting four repetitions of a msg4 PDSCH and is applying a redundancy version sequence of RV1, RV0, RV2, and RV3 to the respective msg4 PDSCH transmissions. In such examples, the rv Index indicated by the first DCI is one, the rv Index indicated by the second DCI is zero, the rv Index indicated by the third DCI is two, and the rv Index indicated by the fourth DCI is three. The UE may use the rv Index of the first DCI (e.g., RV1) to determine the repetition factor to apply for the msg4 feedback. Using the example table 800, the UE may determine the repetition factor is two based on the rv Index of the first DCI.

As described above, to decode a msg4 PDSCH, the UE may use a redundancy version indicated by the corresponding DCI. However, to indicate a repetition factor, the rv Index may be set to a codepoint different than the sequence of redundancy versions. In some examples, to decode the initial transmission of a msg4 PDSCH, the UE may use the rv Index indicated by the first DCI. For example, in the above example, the UE may use the RV1 to decode the initial transmission.

In other examples, the UE may be configured to use a configured redundancy version for an initial transmission of a msg4 PDSCH regardless of the rv Index indicated in the corresponding DCI. For example, in the above example in which the sequence of redundancy versions is RV1, RV0, RV2, and RV3, the UE may be configured to use a configured redundancy version for decoding the initial transmission. For example, even though the rv Index indicated by the first DCI is RV1, the UE may be configured to use RV0 to decode the initial transmission. The UE may then use the rv Index indicated in each subsequent DCI for decoding the respective msg4 PDSCH.

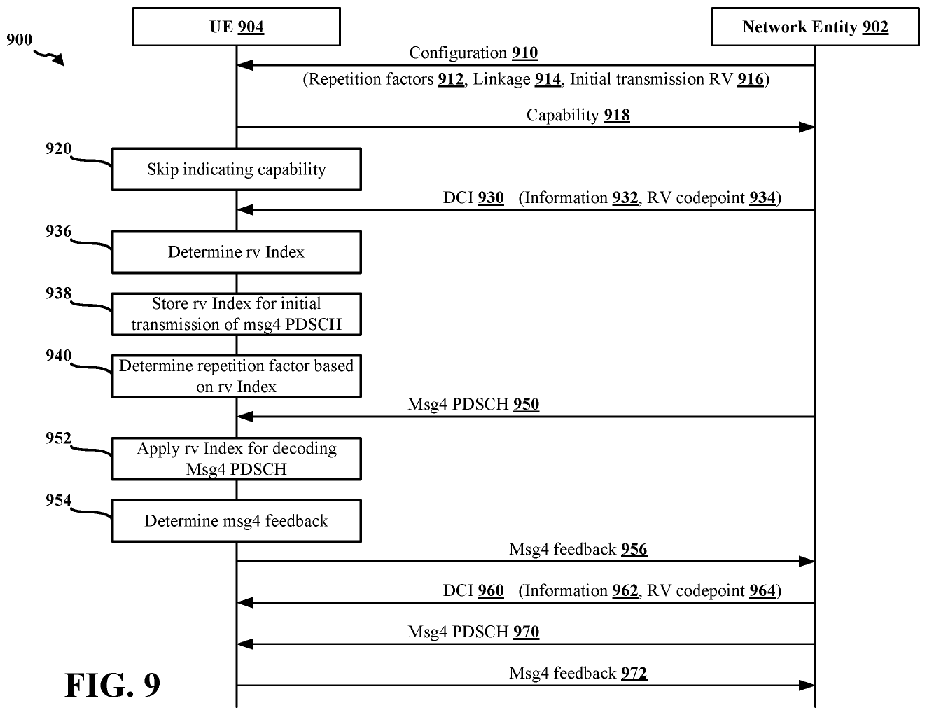

FIG. 9 illustrates an example communication flow 900 between a network entity 902 and a UE 904, as presented herein. One or more aspects described for the network entity 902 may be performed by a component of a base station or a network entity, such as a CU, a DU, and/or an RU. Aspects of the network entity 902 may be implemented by one of the base stations 102 of FIG. 1 and/or the base station 410 of FIG. 4. Aspects of the UE 904 may be implemented by one of the UEs 104 of FIG. 1 and/or the UE 450 of FIG. 4. Although not shown in the illustrated example of FIG. 9, it may be appreciated that in additional or alternative examples, the network entity 902 and/or the UE 904 may be in communication with one or more other base stations or UEs.

Although the following description of FIG. 9 provides examples directed to providing a repetition factor for RACH data transmissions (e.g., the msg4 PDSCH or the msgB PDSCH), the concepts described herein may be applicable to any message with associated HARQ-ACK feedback and for which the repetition factor may be indicated via RRC signaling. For example, the concepts described herein facilitate dynamically indicating the repetition factor for the HARQ-ACK feedback without relying on RRC signaling. That is, the repetition for the HARQ-ACK feedback may be determined before performing an RRC configuration procedure or an RRC reconfiguration procedure.

In the illustrated example, the communication flow 900 facilitates the UE 904 providing feedback (e.g., msg4 feedback 956) with repetition for a last transmission of a RACH procedure (e.g., a msg4 PDSCH 950). Although the example of FIG. 9 illustrates aspects of a four-step RACH procedure, such as the four-step RACH procedure 510 of FIG. 5A, in other examples, the techniques may be applied to a two-step RACH procedure.

In the illustrated example of FIG. 9, the network entity 902 transmits a configuration 910 that is received by the UE 904. In some examples, the configuration 910 may be broadcasted, such as via a system information block (e.g., a SIB1). In some examples, the network entity 902 may provide the configuration 910 via RRC signaling. As shown in FIG. 9, the configuration 910 may indicate a set of repetition factors 912. For example, the set of repetition factors 912 may include multiple repetition factors, such as the set of repetition factors 612 of FIG. 6.

In some examples, the UE 904 may indicate that the UE supports a capability to transmit repetitions of RACH feedback. For example, the UE 904 may transmit a capability 918 that is received by the network entity 902. The capability 918 may indicate to the network entity 902 that the UE 904 supports the capability to transmit repetitions of RACH feedback (e.g., the msg4 feedback 956). In some such examples, the network entity 902 may indicate (e.g., dynamically indicate) a repetition factor for the UE 904 to apply when transmitting the msg4 feedback 956.

In some examples, the UE 904 may provide the capability 918 to the network entity 902 via an earlier RACH transmission to the network entity 902. For example, the UE 904 may provide the capability 918 via a msg3 transmission of a four-step RACH procedure (e.g., the msg3 516 of FIG. 5A) or a msgA transmission of a two-step RACH procedure (e.g., the msgA 562 of FIG. 5B). In some examples, the UE 904 may use reserved codepoints of the earlier RACH transmission to provide the capability 918. In some examples, the UE 904 may use a DMRS port number of the earlier RACH transmission to provide the capability 918.

In some examples, the network entity 902 may operate as if the UE 904 does not support the capability to transmit one or more repetitions of RACH feedback unless the network entity 902 receives the capability 918. Thus, if the UE 904 skips indicating a capability (e.g., at 920), the network entity 902 may determine that the UE 904 lacks the capability to transmit repetitions of RACH feedback and, thus, monitor for a single transmission of the msg4 feedback 956. In other examples, the UE 904 may provide capability information that indicates that the UE 904 lacks the capability to transmit repetitions of RACH feedback. In such examples, the network entity 902 may monitor for a single transmission of the msg4 feedback 956.

As shown in FIG. 9, the network entity 902 may transmit a DCI 930 that is received by the UE 904. The DCI 930 may schedule a msg4 PDSCH 950. Aspects of the DCI 930 may be similar to the DCI 634 of FIG. 6. For example, the DCI 930 of FIG. 9 includes information 932 and an RV codepoint 934. The information 932 may provide information for receiving the msg4 PDSCH 950. For example, the information 932 may indicate frequency resources and/or time resources for receiving the msg4 PDSCH 950.

After receiving the DCI 930, the UE 904 may perform a determining procedure 936 to determine the rv Index indicated by the RV codepoint 934. Aspects of determining the rv Index may be similar to the decoding procedure 640 of FIG. 6. For example, the UE 904 may decode the payload of the DCI 930 to determine the rv Index. In some examples, the UE 904 may be configured with a mapping between the RV codepoint 934 and the rv Index. For example, the UE 904 may use the table 700 of FIG. 7A and/or the table 710 of FIG. 7B to determine the rv Index.

In some examples, the UE 904 may perform a storing procedure 938 to store the rv Index for an initial transmission of a msg4 PDSCH. For example, if the DCI 930 indicates that the msg4 PDSCH 950 is an initial transmission (e.g., via a new data indicator), then the UE 904 may store the rv Index in a buffer.

As shown in FIG. 9, the UE 904 may perform a determining procedure 940 to determine a repetition factor for the msg4 feedback 956 based on the rv Index. For example, the UE 904 may use the rv Index to derive the repetition factor. In some examples, the UE 904 may be configured (or pre-configured) with a linkage 914 between the repetition factor and the rv Index. In some examples, the network entity 902 may signal the linkage 914 between the repetition factor and the rv Index. For example, the network entity 902 may indicate the linkage 914 via the configuration 910. Aspects of the linkage 914 between the repetition factor and the rv Index may be implemented by the table 800 of FIG. 8. For example, the linkage 914 may enable the UE 904 to map the RV codepoint 934 to an rv Index and a repetition factor.

As described in connection with the table 800, the UE 904 may use the rv Index indicated by the DCI 930 to determine the repetition factor when the msg4 PDSCH 950 is an initial transmission. In examples in which the msg4 PDSCH 950 is a retransmission, the UE 904 may use the rv Index stored via the storing procedure 938 to determine the repetition factor.

In the illustrated example of FIG. 9, the network entity 902 transmits a msg4 PDSCH 950 that is received by the UE 904. The UE 904 may perform an applying procedure 952 to apply the rv Index for decoding the msg4 PDSCH 950. In some examples, the UE 904 may use the rv Index indicated by the RV codepoint 934 to decode the msg4 PDSCH 950. For example, and referring to the example table 700 of FIG. 7A, if the RV codepoint 934 is “01,” then the UE 904 may use RV1 to decode the msg4 PDSCH 950.

In other examples, the UE 904 may be configured with an initial transmission redundancy version 916 to apply when the msg4 PDSCH 950 is an initial transmission. For example, the initial transmission redundancy version 916 may be set to RV0. In such examples, regardless of the RV codepoint 934, the UE 904 may use RV0 to decode the msg4 PDSCH 950 when the msg4 PDSCH 950 is an initial transmission. In examples in which the msg4 PDSCH 950 is a retransmission, then the UE 904 uses the RV index based on the RV codepoint 934 to decode the msg4 PDSCH 950.

In some examples, the UE 904 may be configured (or pre-configured) with the initial transmission redundancy version 916. In some examples, the network entity 902 may signal the initial transmission redundancy version 916. For example, the network entity 902 may indicate the initial transmission redundancy version 916 via the configuration 910.

In the illustrated example of FIG. 9, the UE 904 may perform a feedback procedure 954 to determine feedback for the msg4. For example, the UE 904 may determine an ACK when the UE 904 successfully receives the msg4 PDSCH 950. The UE 904 may determine a NACK when the UE 904 is unsuccessful in receiving the msg4 PDSCH 950. As shown in FIG. 9, the UE 904 outputs a msg4 feedback 956 that is received by the network entity 902. The UE 904 may use the PUCCH resources configured by the configuration 910 to transmit the msg4 feedback 956. Additionally, the UE 904 may transmit the msg4 feedback 956 with repetitions based on the repetition factor determined via the determining procedure 940.

In some examples, a UE may miss detection of DCI scheduling a msg4 PDSCH. For example, the UE 604 may miss detection of the DCI 930 based on poor channel conditions. If the UE 904 misses detection of the DCI 930, then the UE 904 may also miss detection of the msg4 PDSCH 950 and, thus, may not transmit the msg4 feedback 956. In such examples, the network entity 902 may determine to transmit another msg4 PDSCH, for example, based on an absence of detecting the msg4 feedback 956. For example, the network entity 902 may transmit a DCI 960 that indicates information 962 and an RV codepoint 964. Aspects of the DCI 960, the information 962, and the RV codepoint 964 may be similar to the DCI 930, the information 932, and the RV codepoint 934, respectively. The network entity 902 may then transmit a msg4 PDSCH 970 that is received by the UE 904.

In some examples, when the network entity 902 determines to transmit the DCI 960 and the msg4 PDSCH 970 based on an absence of detecting the msg4 feedback 956, the network entity 902 may “re-fresh” the msg4 PDSCH by indicating that the next msg4 PDSCH (e.g., the msg4 PDSCH 970) is an initial transmission of the msg4 PDSCH. For example, the network entity 902 may set a new data indicator of the information 962 to indicate that the msg4 PDSCH 970 is an initial transmission. In such examples, the UE 904 may apply the techniques disclosed herein to, based on the RV codepoint 96, determine the redundancy version and the repetition factor to apply to msg4 feedback 972 for the msg4 PDSCH 970.

In other examples, the network entity may transmit the msg4 PDSCH 970 as a retransmission of the msg4 PDSCH 950. In some such examples, the network entity 902 may set the RV codepoint 964 to a value that is linked to a repetition factor for the msg4 feedback 972. For example, even though the network entity 902 is transmitting the msg4 PDSCH 970 as a retransmission, it is the first PDSCH transmission that the UE 904 detects. For example, the RV codepoint 934 of the DCI 930 may be set to “01,” which indicates an RV1. The RV codepoint 964 of the DCI 960 may be set to “00,” which indicates an RV0. Since the repetition factors associated with RV1 and RV0 are different, the UE 904 may transmit the msg4 feedback 972 with a repetition factor that is different than what the network entity 902 is expecting. For example, the network entity 902 may be monitoring for two repetitions of the msg4 feedback 972 based on the RV1, but the UE 904 may transmit a single repetition of the msg4 feedback 972. Thus, by setting the RV codepoint 964 to an RV codepoint that is linked to a repetition factor, the network entity 902 may know the quantity of repetitions of the msg4 feedback 972 for which to monitor.

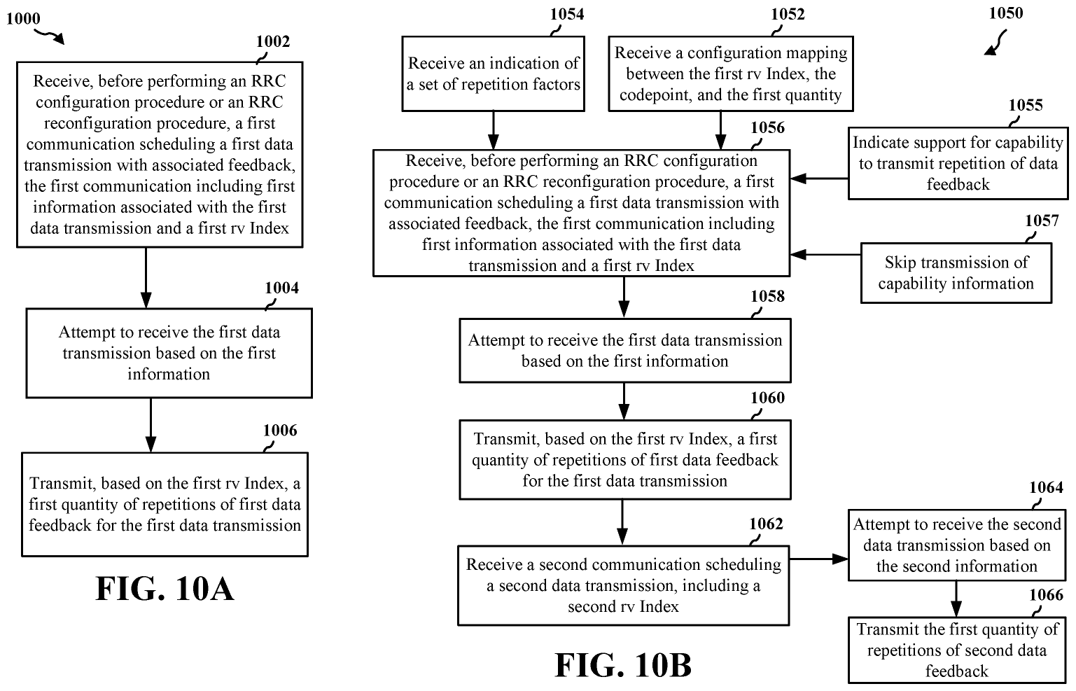

FIG. 10A is a flowchart 1000 of a method of wireless communication. The method may be performed by a UE (e.g., one of the UEs 104; the apparatus 1104).

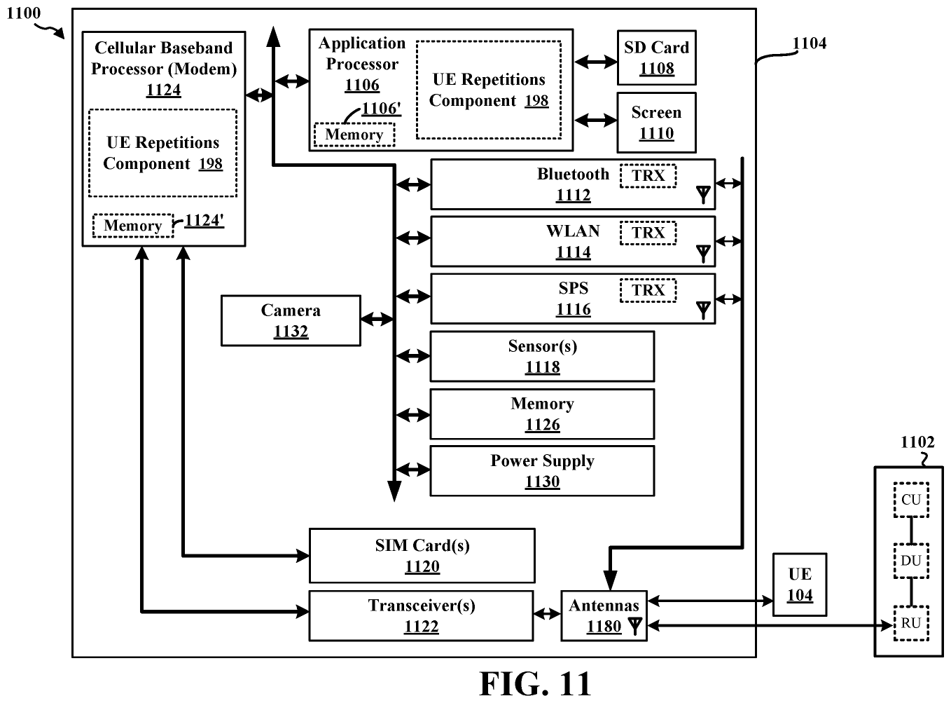

At 1002, the UE receives, before performing an RRC configuration procedure or an RRC reconfiguration procedure, a first communication scheduling a first data transmission with associated feedback, the first communication including first information associated with the first data transmission and a first rv Index. The first data transmission may include a Msg4 of a four-step RACH procedure, a MsgB of a two-step RACH procedure, or another message with associated HARQ-ACK feedback (e.g., for which HARQ-ACK feedback is required) and configured via RRC signaling. The reception may be performed, e.g., by the UE repetitions component 198 of the apparatus 1104 and/or the cellular RF transceiver 1122 or the one or more antennas 1180 in FIG. 11, as an example.

At 1004, the UE attempts to receive the first data transmission based on the first information. For example, the UE may monitor for the first data transmission and may determine whether the first data transmission is received correctly. The UE may provide feedback indicating whether or not the first data transmission is successfully received. The attempt may be performed, e.g., by the UE repetitions component 198 of the apparatus 1104, as an example.

At 1006, the UE transmits, based on the first rv Index, a first quantity of repetitions of first data feedback for the first data transmission. The feedback indicates whether or not the UE received the first data transmission (e.g., Msg4, MsgB, etc.). The number of repetitions of the feedback is based on the first rv Index. In some aspects, a codepoint based on the first rv Index maps to the first quantity. The transmission may be performed, e.g., by the UE repetitions component 198 of the apparatus 1104 and/or the cellular RF transceiver 1122 or the one or more antennas 1180 in FIG. 11, as an example.

FIG. 10B is a flowchart 1050 of a method of wireless communication. The method may be performed by a UE (e.g., one of the UEs 104; the apparatus 1104).

At 1052, the UE may receive a configuration configuring a mapping between the first rv Index and the first quantity. As an example, a linkage between PUCCH repetition and rv Index for an initial transmission of a Msg4 (or MsgB) PDSCH can be broadcasted or configured via SIB1 and/or RRC based configurations. The reception may be performed, e.g., by the UE repetitions component 198 of the apparatus 1104 and/or the cellular RF transceiver 1122 or the one or more antennas 1180 in FIG. 11, as an example.

At 1054, the UE may receive an indication of a set of repetition factors. The set of repetition factors may include at least two values. The set of repetition factors may include the first quantity of repetitions. As an example, the network may indicate to the UE the repetition factor if multiple repetition factors are configured. The reception may be performed, e.g., by the UE repetitions component 198 of the apparatus 1104 and/or the cellular RF transceiver 1122 or the one or more antennas 1180 in FIG. 11, as an example.

At 1056, the UE receives, before performing an RRC configuration procedure or an RRC reconfiguration procedure, a first communication scheduling a first data transmission with associated feedback, the first communication including first information associated with the first data transmission and a first rv Index. The first data transmission may include a Msg4 of a four-step RACH procedure, a MsgB of a two-step RACH procedure, or another message with associated HARQ-ACK feedback (e.g., for which HARQ-ACK feedback is required) and configured via RRC signaling. The reception may be performed, e.g., by the UE repetitions component 198 of the apparatus 1104 and/or the cellular RF transceiver 1122 or the one or more antennas 1180 in FIG. 11, as an example.

At 1058, the UE attempts to receive the first data transmission based on the first information. For example, the UE may monitor for the first data transmission and may determine whether the first data transmission is received correctly. The UE may provide feedback indicating whether or not the first data transmission is successfully received. In some examples, attempting to receive the first data transmission includes applying a second rv Index to a PDSCH transmission received based on the first information, where the second rv Index is a configured value applied to a new data transmission. As an example, the UE may assume an rv Index=0 (e.g., as the second rv Index) for an initial transmission of a Msg4 PDSCH. The second rv Index can be configured, defined, or signaled to the UE. In some aspects, attempting to receive the first data transmission may include applying the first rv Index to a PDSCH transmission received based on the first information. For example, the UE may use the rv Index indicate in DCI, in some aspects. The attempt may be performed, e.g., by the UE repetitions component 198 of the apparatus 1104 in FIG. 11, as an example.

At 1060, the UE transmits, based on the first rv Index, a first quantity of repetitions of first data feedback for the first RACH transmission. As an example, the feedback may indicate whether or not the UE received the first data transmission (e.g., Msg4, MsgB, etc.). The number of repetitions of the feedback is based on the first rv Index. In some aspects, the first rv Index maps to the first quantity. The transmission may be performed, e.g., by the UE repetitions component 198 of the apparatus 1104 and/or the cellular RF transceiver 1122 or the one or more antennas 1180 in FIG. 11, as an example.

As illustrated at 1055, the UE may indicate that the UE supports a capability to transmit one or more repetitions of data feedback, e.g., which may be referred to as a UE capability for PUCCH repetition, e.g., for Msg3. Then, at 1056, the UE may then use the first rv Index to determine the first quantity of repetitions based on the UE's support for the capability. The indication may be performed, e.g., by the UE repetitions component 198 of the apparatus 1104 and/or the cellular RF transceiver 1122 or the one or more antennas 1180 in FIG. 11, as an example.

As illustrated at 1057, in some aspects, the UE may skip the transmission of capability information indicating that the UE supports a capability to transmit one or more repetitions of data feedback. Then, at 1060, the UE may transmit one repetition of the first data feedback. As an example, if the UE does not signal support for the UE capability, the UE may use the indicated rv Index for the initial transmission for decoding Msg4 PDSCH and may ignore the linkage with a repetition factor in a table.

In some aspects, at 1062, the UE may receive a second communication scheduling a second data transmission, the second communication including second information associated with the second data transmission and a second rv Index, and where the second data transmission is a retransmission of the first data transmission. For example, for a retransmission of the Msg4 PDSCH, the UE may associate the rv Index in the DCI received for the initial transmission as the PUCCH repetition factor. The reception may be performed, e.g., by the UE repetitions component 198 of the apparatus 1104 and/or the cellular RF transceiver 1122 or the one or more antennas 1180 in FIG. 11, as an example.

At 1064, the UE may attempt to receive the second data transmission based on the second information. For example, the UE may monitor for the second data transmission and may determine whether the second data transmission is received correctly. The UE may provide feedback indicating whether or not the second data transmission is successfully received. The attempt may be performed, e.g., by the UE repetitions component 198 of the apparatus 1104 and/or the cellular RF transceiver 1122 or the one or more antennas 1180 in FIG. 11, as an example.

At 1066, the UE may transmit the first quantity of repetitions of second data feedback for the second data transmission. As an example, the second feedback may indicate whether or not the UE received the second RACH transmission (e.g., Msg4, MsgB, etc.). The number of repetitions of the second feedback is based on the first rv Index. For example, the UE may store (e.g., in a buffer) the rv Index in the DCI received for the initial transmission and use the rv Index to determine the number of repetitions of the second feedback. The transmission may be performed, e.g., by the UE repetitions component 198 of the apparatus 1104 and/or the cellular RF transceiver 1122 or the one or more antennas 1180 in FIG. 11, as an example.

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include a cellular baseband processor 1124 (also referred to as a modem) coupled to one or more transceivers (e.g., a cellular RF transceiver 1122). The cellular baseband processor 1124 may include on-chip memory 1124′. In some aspects, the apparatus 1104 may further include one or more subscriber identity modules (SIM) cards 1120 and an application processor 1106 coupled to a secure digital (SD) card 1108 and a screen 1110. The application processor 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize one or more antennas 1180 for communication. The cellular baseband processor 1124 communicates through transceiver(s) (e.g., the cellular RF transceiver 1122) via one or more antennas 1180 with one of the UEs 104 and/or with an RU associated with a network entity 1102. The cellular baseband processor 1124 and the application processor 1106 may each include a computer-readable medium/memory, such as the on-chip memory 1124′, and the on-chip memory 1106′, respectively. The additional memory modules 1126 may also be considered a computer-readable medium/memory. Each computer-readable medium/memory (e.g., the on-chip memory 1124′, the on-chip memory 1106′, and/or the additional memory modules 1126) may be non-transitory. The cellular baseband processor 1124 and the application processor 1106 are each responsible for general processing, including the execution of software stored on the computer-readable medium/memory. The software, when executed by the cellular baseband processor 1124/application processor 1106, causes the cellular baseband processor 1124/application processor 1106 to perform the various functions described supra. The computer-readable medium/memory may also be used for storing data that is manipulated by the cellular baseband processor 1124/application processor 1106 when executing software. The cellular baseband processor 1124/application processor 1106 may be a component of the UE 450 and may include the memory 460 and/or at least one of the TX processor 468, the RX processor 456, and the controller/processor 459. In one configuration, the apparatus 1104 may be a processor chip (modem and/or application) and include just the cellular baseband processor 1124 and/or the application processor 1106, and in another configuration, the apparatus 1104 may be the entire UE (e.g., see the UE 450 of FIG. 4) and include the additional modules of the apparatus 1104.

As discussed supra, the UE repetitions component 198 may be configured to receive, before performing an RRC configuration procedure or an RRC reconfiguration procedure, a first communication scheduling a first data transmission with associated feedback, the first communication including first information associated with the first data transmission and a first rv Index; attempt to receive the first data transmission based on the first information; and transmit, based on the first rv Index, a first quantity of repetitions of first data feedback for the first data transmission. In some aspects, the UE repetitions component 198 may be further configured to receive a configuration configuring a mapping between the first rv Index and the first quantity of the repetitions. In some aspects, the UE repetitions component 198 may be further configured to receive an indication of a set of repetition factors, the set of repetition factors including at least two values, and where the set of repetition factors includes the first quantity. In some aspects, the UE repetitions component 198 may be further configured to apply a second rv Index to a PDSCH transmission received based on the first information, where the second rv Index is a configured value applied to a new data transmission. In some aspects, the UE repetitions component 198 may be further configured to apply the first rv Index to a PDSCH transmission received based on the first information. In some aspects, the UE repetitions component 198 may be further configured to store the first rv Index of the first communication; receive a second communication scheduling a second data transmission, the second communication including second information associated with the second data transmission and a second rv Index, where the second data transmission is a retransmission of the first data transmission; attempt to receive the second RACH transmission based on the second information; and transmit the first quantity of repetitions of second data feedback for the second data transmission based on the first rv Index. In some aspects, the UE repetitions component 198 may be further configured to indicate that the UE supports a capability to transmit one or more repetitions of data feedback; and use the first rv Index to determine the first quantity based on support for the capability. In some aspects, the UE repetitions component 198 may be further configured to skip transmission of capability information indicating that the UE supports a capability to transmit one or more repetitions of data feedback; and transmit one repetition of the first data feedback. The component may be further configured to perform any of the aspects described in connection with the flowchart in FIG. 10A or 10B, and/or performed by the UE in the communication flow in FIG. 9.

The UE repetitions component 198 may be within the cellular baseband processor 1124, the application processor 1106, or both the cellular baseband processor 1124 and the application processor 1106. The UE repetitions component 198 may be one or more hardware components specifically configured to carry out the stated processes/algorithm, implemented by one or more processors configured to perform the stated processes/algorithm, stored within a computer-readable medium for implementation by one or more processors, or some combination thereof.

As shown, the apparatus 1104 may include a variety of components configured for various functions. For example, the UE repetitions component 198 may include one or more hardware components that perform each of the blocks of the algorithm in the flowcharts of FIG. 10A and/or FIG. 10B.

In one configuration, the apparatus 1104, and in particular the cellular baseband processor 1124 and/or the application processor 1106, may include means for receiving, before performing an RRC configuration procedure or an RRC reconfiguration procedure, a first communication scheduling a first data transmission with associated feedback, the first communication including first information associated with the first data transmission and a first rv Index; means for attempting to receive the first data transmission based on the first information; and means for transmitting, based on the first rv Index, a first quantity of repetitions of first data feedback for the first data transmission. In some aspects, the apparatus may further include means for receiving a configuration configuring a mapping between the first rv Index and the first quantity. In some aspects, the apparatus may further include means for receiving an indication of a set of repetition factors, the set of repetition factors including at least two values, and where the set of repetition factors includes the first quantity. In some aspects, the apparatus may further include means for applying a second rv Index to a PDSCH transmission received based on the first information, where the second rv Index is a configured value applied to a new data transmission. In some aspects, the apparatus may further include means for applying the first rv Index to a PDSCH transmission received based on the first information. In some aspects, the apparatus may further include means for storing the first rv Index of the first communication; receiving a second communication scheduling a second data transmission, the second communication including second information associated with the second data transmission and a second rv Index, where the second data transmission is a retransmission of the first data transmission; means for attempting to receive the second data transmission based on the second information; and means for transmitting the first quantity of repetitions of second data feedback for the second data transmission based on the first rv Index. In some aspects, the apparatus may further include means for indicating that the UE supports a capability to transmit one or more repetitions of data feedback; and means for using the first rv Index to determine the first quantity based on support for the capability. In some aspects, the apparatus may further include means for skipping transmission of capability information indicating that the UE supports a capability to transmit one or more repetitions of data feedback; and means for transmitting one repetition of the first data feedback.

The means may be the UE repetitions component 198 of the apparatus 1104 configured to perform the functions recited by the means. As described supra, the apparatus 1104 may include the TX processor 468, the RX processor 456, and the controller/processor 459. As such, in one configuration, the means may be the TX processor 468, the RX processor 456, and/or the controller/processor 459 configured to perform the functions recited by the means.

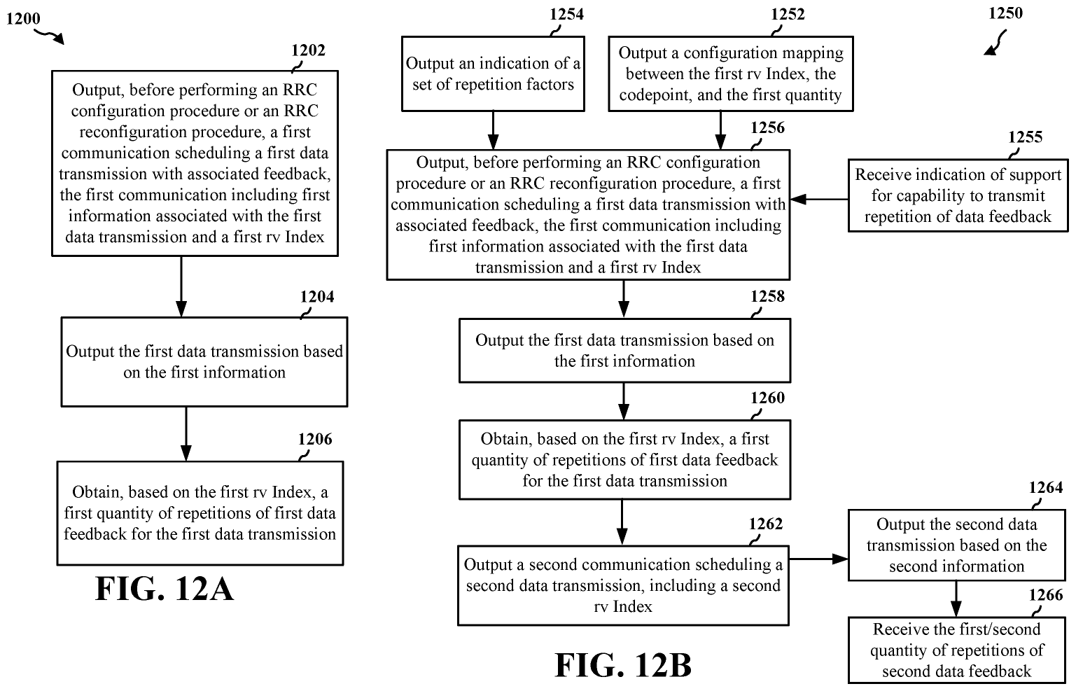

FIG. 12A is a flowchart 1200 of a method of wireless communication. The method may be performed by a base station, network entity, or network node (e.g., one of the base stations 102; the network entity 1102, the CU, the DU, and/or the RU).

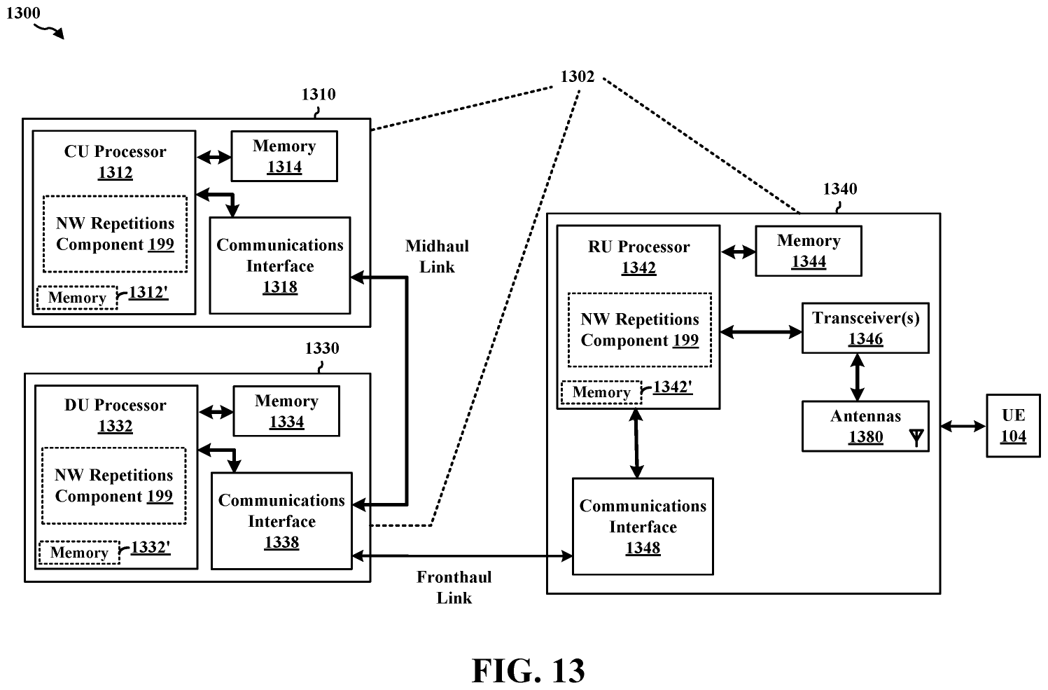

At 1202, the network node outputs, before performing an RRC configuration procedure or an RRC reconfiguration procedure, a first communication scheduling a first data transmission with associated feedback, the first communication including first information associated with the first data transmission and a first rv Index. The first data transmission may include a Msg4 of a four-step RACH procedure, a MsgB of a two-step RACH procedure, or another message with associated HARQ-ACK feedback (e.g., for which HARQ-ACK feedback is required) and configured via RRC signaling. The output may be performed, e.g., by the NW repetitions component 199 of the network entity 1302 and/or the one or more transceivers 1346 or the one or more antennas 1380 in FIG. 13, as an example.

At 1204, the network node outputs the first data transmission based on the first information. For example, the network node may receive feedback from a UE indicating whether or not the UE received the first data transmission successfully. The output may be performed, e.g., by the NW repetitions component 199 of the network entity 1302 and/or the one or more transceivers 1346 or the one or more antennas 1380 in FIG. 13, as an example.

At 1206, the network node receives, based on the first rv Index, a first quantity of repetitions of first data feedback for the first data transmission. The feedback indicates whether or not the UE received the first data transmission (e.g., Msg4 or MsgB). The number of repetitions of the feedback is based on the first rv Index. In some aspects, a codepoint based on the first rv Index maps to the first quantity. The reception may be performed, e.g., by the NW repetitions component 199 of the network entity 1302 and/or the one or more transceivers 1346 or the one or more antennas 1380 in FIG. 13, as an example.

FIG. 12B is a flowchart 1250 of a method of wireless communication. The method may be performed by a base station, network entity, or network node (e.g., one of the base stations 102; the network entity 1102, the CU, the DU, and/or the RU).

At 1252, the network node may output a configuration configuring a mapping between the first rv Index and the first quantity. As an example, a linkage between PUCCH repetition and rv Index for an initial transmission of a Msg4 (or MsgB) PDSCH can be broadcasted or configured via SIB1 and/or RRC based configurations. The output may be performed, e.g., by the NW repetitions component 199 of the network entity 1302 and/or the one or more transceivers 1346 or the one or more antennas 1380 in FIG. 13, as an example.

At 1254, the network node may output an indication of a set of repetition factors. The set of repetition factors may include at least two values. The set of repetition factors may include the first quantity. As an example, the network may indicate to the UE the repetition factor if multiple repetition factors are configured. The output may be performed, e.g., by the NW repetitions component 199 of the network entity 1302 and/or the one or more transceivers 1346 or the one or more antennas 1380 in FIG. 13, as an example.

At 1256, the network node outputs, before performing an RRC configuration procedure or an RRC reconfiguration procedure, a first communication scheduling a first data transmission with associated feedback, the first communication including first information associated with the first data transmission and a first rv Index. The first data transmission may include a Msg4 of a four-step RACH procedure, a MsgB of a two-step RACH procedure, or another message with associated HARQ-ACK feedback (e.g., for which HARQ-ACK feedback is required) and configured via RRC signaling. The output may be performed, e.g., by the NW repetitions component 199 of the network entity 1302 and/or the one or more transceivers 1346 or the one or more antennas 1380 in FIG. 13, as an example.

At 1258, the network node outputs the first data transmission based on the first information. For example, the network node may receive feedback from a UE indicating whether or not the UE received the first data transmission successfully. The output may be performed, e.g., by the NW repetitions component 199 of the network entity 1302 and/or the one or more transceivers 1346 or the one or more antennas 1380 in FIG. 13, as an example.

At 1260, the network node receives, based on the first rv Index, a first quantity of repetitions of first data feedback for the first data transmission. The feedback indicates whether or not the UE received the first data transmission (e.g., Msg4, MsgB, etc.). The number of repetitions of the feedback is based on the first rv Index. In some aspects, the first rv Index maps to the first quantity. The reception may be performed, e.g., by the NW repetitions component 199 of the network entity 1302.

As illustrated at 1255, the network node may receive an indication that the UE supports a capability to transmit one or more repetitions of data feedback, e.g., which may be referred to as a UE capability for PUCCH repetition, e.g., for Msg3. The first rv Index may be based on the UE's support for the capability. The network entity may then monitor for the first quantity of the repetitions of the first data feedback based on the capability. The reception may be performed, e.g., by the NW repetitions component 199 of the network entity 1302 and/or the one or more transceivers 1346 or the one or more antennas 1380 in FIG. 13, as an example.

As illustrated at 1262, the network entity may output a second communication scheduling a second data transmission, the second communication including second information associated with the second data transmission and a second rv Index, and where the second data transmission is a retransmission of the first data transmission, and at 1264, may output the second data transmission based on the second information. The output may be performed, e.g., by the NW repetitions component 199 of the network entity 1302 and/or the one or more transceivers 1346 or the one or more antennas 1380 in FIG. 13, as an example. Then, at 1266, the network entity may obtain the first quantity of repetitions of second data feedback for the second data transmission. In some aspects, at 1262, the network node may output a second communication scheduling a second data transmission, the second communication including second information associated with the second data transmission and a second rv Index, where the second data transmission is a first new data transmission and output a third communication scheduling a third data transmission based on an absence of detecting second data feedback for the second data transmission, the third communication including third information associated with the third data transmission and a third rv Index, where the third data transmission is a second new data transmission. The output may be performed, e.g., by the NW repetitions component 199 of the network entity 1302 and/or the one or more transceivers 1346 or the one or more antennas 1380 in FIG. 13, as an example. The network node may then monitor, based on the third rv Index, for a second quantity of repetitions of third data feedback for the third data transmission, e.g., at 1266.

In some aspects, the network node may output, at 1262, a second communication scheduling a second data transmission, the second communication including second information associated with the second data transmission and a second rv Index, where the second data transmission is a new data transmission and output a third communication scheduling a third data transmission based on an absence of detecting second data feedback for the second data transmission, the third communication including third information associated with the third data transmission and a third rv Index, where the third data transmission is a retransmission of the second data transmission. The output may be performed, e.g., by the NW repetitions component 199 of the network entity 1302 and/or the one or more transceivers 1346 or the one or more antennas 1380 in FIG. 13, as an example. Then, the network node may monitor, based on the third rv Index, for a second quantity of repetitions of third data feedback for the third data transmission.

FIG. 13 is a diagram 1300 illustrating an example of a hardware implementation for a network entity 1302. The network entity 1302 may be a BS, a component of a BS, or may implement BS functionality. The network entity 1302 may include at least one of a CU 1310, a DU 1330, or an RU 1340. For example, depending on the layer functionality handled by the NW repetitions component 199, the network entity 1302 may include the CU 1310; both the CU 1310 and the DU 1330; each of the CU 1310, the DU 1330, and the RU 1340; the DU 1330; both the DU 1330 and the RU 1340; or the RU 1340. The CU 1310 may include a CU processor 1312. The CU processor 1312 may include on-chip memory 1312′. In some aspects, may further include additional memory modules 1314 and a communications interface 1318. The CU 1310 communicates with the DU 1330 through a midhaul link, such as an F1 interface. The DU 1330 may include a DU processor 1332. The DU processor 1332 may include on-chip memory 1332′. In some aspects, the DU 1330 may further include additional memory modules 1334 and a communications interface 1338. The DU 1330 communicates with the RU 1340 through a fronthaul link. The RU 1340 may include an RU processor 1342. The RU processor 1342 may include on-chip memory 1342′. In some aspects, the RU 1340 may further include additional memory modules 1344, one or more transceivers 1346, one or more antennas 1380, and a communications interface 1348. The RU 1340 communicates with one of the UEs 104. The on-chip memories (e.g., the on-chip memory 1312′, the on-chip memory 1332′, and/or the on-chip memory 1342′) and/or the additional memory modules (e.g., the additional memory modules 1314, the additional memory modules 1334, and/or the additional memory modules 1344) may each be considered a computer-readable medium/memory. Each computer-readable medium/memory may be non-transitory. Each of the CU processor 1312, the DU processor 1332, the RU processor 1342 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the NW repetitions component 199 may be configured to output, before performing an RRC configuration procedure or an RRC reconfiguration procedure, a first communication scheduling a first data transmission with associated feedback, the first communication including first information associated with the first data transmission and a first rv Index; output the first data transmission based on the first information; and obtain, based on the first rv Index, a first quantity of repetitions of first data feedback for the first data transmission. The NW repetitions component 199 may be further configured to configure a mapping between the first rv Index and the first quantity. The NW repetitions component 199 may be further configured to configure a set of repetition factors, the set of repetition factors including at least two values, and where the set of repetition factors includes the first quantity. The NW repetitions component 199 may be further configured to output a second communication scheduling a second data transmission, the second communication including second information associated with the second data transmission and a second rv Index, where the second data transmission is a retransmission of the first data transmission; output the second data transmission based on the second information; and obtain the first quantity of repetitions of second data feedback for the second data transmission. The NW repetitions component 199 may be further configured to obtain an indication that a UE supports a capability to transmit one or more repetitions of data feedback; and monitor for the first quantity of the repetitions of the first data feedback based on the capability. The NW repetitions component 199 may be further configured to output a second communication scheduling a second data transmission, the second communication including second information associated with the second data transmission and a second rv Index, and where the second data transmission is a first new data transmission; output a third communication scheduling a third data transmission based on an absence of detecting second data feedback for the second data transmission, the third communication including third information associated with the third data transmission and a third rv Index, and where the third data transmission is a second new data transmission; and monitor, based on the third rv Index, for a second quantity of repetitions of third data feedback for the third data transmission. The NW repetitions component 199 may be further configured to output a second communication scheduling a second data transmission, the second communication including second information associated with the second data transmission and a second rv Index, and where the second data transmission is a new data transmission; output a third communication scheduling a third data transmission based on an absence of detecting second data feedback for the second data transmission, the third communication including third information associated with the third data transmission and a third rv Index, and where the third data transmission is a retransmission of the second data transmission; and monitor, based on the third rv Index, for a second quantity of repetitions of third data feedback for the third data transmission. The NW repetitions component 199 may be further configured to perform any of the aspects described in connection with FIG. 12A, FIG. 12B, and/or the aspects performed by the network in the communication flow in FIG. 9.

The NW repetitions component 199 may be within one or more processors of one or more of the CU 1310, DU 1330, and the RU 1340. The NW repetitions component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1302 may include a variety of components configured for various functions.

In one configuration, the network entity 1302 may include means for outputting, before performing an RRC configuration procedure or an RRC reconfiguration procedure, a first communication scheduling a first data transmission with associated feedback, the first communication including first information associated with the first data transmission and a first rv Index; means for outputting the first data transmission based on the first information; and means for obtaining, based on the first rv Index, a first quantity of repetitions of first data feedback for the first data transmission. In some aspects, the network entity 1302 may further include means for configuring a mapping between the first rv Index and the first quantity. In some aspects, the network entity 1302 may further include means for configuring a set of repetition factors, the set of repetition factors including at least two values, and where the set of repetition factors includes the first quantity. In some aspects, the network entity 1302 may further include means for outputting a second communication scheduling a second data transmission, the second communication including second information associated with the second data transmission and a second rv Index, where the second data transmission is a retransmission of the first data transmission; means for outputting the second data transmission based on the second information; and means for obtaining the first quantity of repetitions of second data feedback for the second data transmission. In some aspects, the network entity 1302 may further include means for obtaining an indication that a UE supports a capability to transmit one or more repetitions of data feedback; and means for monitoring for the first quantity of the repetitions of the first data feedback based on the capability. In some aspects, the network entity 1302 may further include means for outputting a second communication scheduling a second data transmission, the second communication including second information associated with the second data transmission and a second rv Index, where the second data transmission is a first new data transmission; means for outputting a third communication scheduling a third data transmission based on an absence of detecting second data feedback for the second data transmission, the third communication including third information associated with the third data transmission and a third rv Index, where the third data transmission is a second new data transmission; and means for monitoring, based on the third rv Index, for a second quantity of repetitions of third data feedback for the third data transmission. In some aspects, the network entity 1302 may further include means for outputting a second communication scheduling a second data transmission, the second communication including second information associated with the second data transmission and a second rv Index, where the second data transmission is a new data transmission; means for outputting a third communication scheduling a third data transmission based on an absence of detecting second data feedback for the second data transmission, the third communication including third information associated with the third data transmission and a third rv Index, where the third data transmission is a retransmission of the second data transmission; and means for monitoring, based on the third rv Index, for a second quantity of repetitions of third data feedback for the third data transmission.

The network entity 1302 may further include means for performing any of the aspects described in connection with FIG. 12A, FIG. 12B, and/or the aspects performed by the network in the communication flow in FIG. 9. The means may be the NW repetitions component 199 of the network entity 1302 configured to perform the functions recited by the means. As described supra, the network entity 1302 may include the TX processor 416, the RX processor 470, and the controller/processor 475. As such, in one configuration, the means may be the TX processor 416, the RX processor 470, and/or the controller/processor 475 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including: receiving, before performing an RRC configuration procedure or an RRC reconfiguration procedure, a first communication scheduling a first data transmission with associated feedback, the first communication including first information associated with the first data transmission and a first rv Index; attempting to receive the first data transmission based on the first information; and transmitting, based on the first rv Index, a first quantity of repetitions of first data feedback for the first data transmission.

Aspect 2 is the method of aspect 1, further including that the first rv Index maps to the first quantity of the repetitions.

Aspect 3 is the method of any of aspects 1 and 2, further including: receiving a configuration configuring a mapping between the first rv Index and the first quantity of the repetitions.

Aspect 4 is the method of any of aspects 1 to 3, further including: receiving an indication of a set of repetition factors, and where the set of repetition factors includes the first quantity of the repetitions.

Aspect 5 is the method of aspect 4, further including that the set of repetition factors includes at least two values.

Aspect 6 is the method of any of aspects 1 to 5, further including that attempting to receive the first data transmission includes: applying a second rv Index to a PDSCH transmission received based on the first information.

Aspect 7 is the method of aspect 6, further including that the second rv Index is a configured value applied to a new data transmission.

Aspect 8 is the method of any of aspects 1 to 5, further including that attempting to receive the first data transmission includes: applying the first rv Index to a PDSCH transmission received based on the first information.

Aspect 9 is the method of any of aspects 1 to 8, further including: storing the first rv Index of the first communication; receiving a second communication scheduling a second data transmission, the second communication including second information associated with the second data transmission and a second rv Index, where the second data transmission is a retransmission of the first data transmission; attempting to receive the second data transmission based on the second information; and transmitting the first quantity of repetitions of second data feedback for the second data transmission based on the first rv Index.

Aspect 10 is the method of any of aspects 1 to 9, further including: indicating that the UE supports a capability to transmit one or more repetitions of data feedback; and using the first rv Index to determine the first quantity of the repetitions based on support for the capability.

Aspect 11 is the method of any of aspects 1 to 10, further including: skipping transmission of capability information indicating that the UE supports a capability to transmit one or more repetitions of data feedback; and transmitting one repetition of the first data feedback.

Aspect 12 is an apparatus for wireless communication at a UE including at least one processor coupled to a memory and configured to implement any of aspects 1 to 11.

In aspect 13, the apparatus of aspect 12 further includes at least one antenna coupled to the at least one processor.

In aspect 14, the apparatus of aspect 12 or 13 further includes a transceiver coupled to the at least one processor.

Aspect 15 is an apparatus for wireless communication including means for implementing any of aspects 1 to 11.

In aspect 16, the apparatus of aspect 15 further includes at least one antenna coupled to the means to perform the method of any of aspects 1 to 11.

In aspect 17, the apparatus of aspect 15 or 16 further includes a transceiver coupled to the means to perform the method of any of aspects 1 to 11.

Aspect 18 is a non-transitory computer-readable storage medium storing computer executable code, where the code, when executed, causes a processor to implement any of aspects 1 to 11.

Aspect 19 is a method of wireless communication at a network entity, including: outputting, before performing an RRC configuration procedure or an RRC reconfiguration procedure, a first communication scheduling a first data transmission with associated feedback, the first communication including first information associated with the first data transmission and a first rv Index; outputting the first data transmission based on the first information; and obtaining, based on the first rv Index, a first quantity of repetitions of first data feedback for the first data transmission.

Aspect 20 is the method of aspect 19, further including that the first rv Index maps to the first quantity of the repetitions.

Aspect 21 is the method of any of aspects 19 and 20, further including: configuring a mapping between the first rv Index and the first quantity of the repetitions.

Aspect 22 is the method of any of aspects 19 to 21, further including: configuring a set of repetition factors, and where the set of repetition factors includes the first quantity of the repetitions.

Aspect 23 is the method of any of aspects 19 to 22, further including that the set of repetition factors includes at least two values.

Aspect 24 is the method of any of aspects 19 to 22, further including: outputting a second communication scheduling a second data transmission, the second communication including second information associated with the second data transmission and a second rv Index, where the second data transmission is a retransmission of the first data transmission; outputting the second data transmission based on the second information; and obtaining the first quantity of the repetitions of second data feedback for the second data transmission.

Aspect 25 is the method of any of aspects 19 to 24, further including: obtaining an indication that a UE supports a capability to transmit one or more repetitions of data feedback; and monitoring for the first quantity of the repetitions of the first data feedback based on the capability.

Aspect 26 is the method of any of aspects 19 to 25, further including comprising: outputting a second communication scheduling a second data transmission, the second communication including second information associated with the second data transmission and a second rv Index, where the second data transmission is a first new data transmission; outputting a third communication scheduling a third data transmission based on an absence of detecting second data feedback for the second data transmission, the third communication including third information associated with the third data transmission and a third rv Index, where the third data transmission is a second new data transmission; and monitoring, based on the third rv Index, for a second quantity of repetitions of third data feedback for the third data transmission.

Aspect 27 is the method of any of aspects 19 to 26, further including comprising: outputting a second communication scheduling a second data transmission, the second communication including second information associated with the second data transmission and a second rv Index, where the second data transmission is a new data transmission; outputting a third communication scheduling a third data transmission based on an absence of detecting second data feedback for the second data transmission, the third communication including third information for receiving the third data transmission and a third rv Index, where the third data transmission is a retransmission of the second data transmission; and monitoring, based on the third rv Index, for a second quantity of repetitions of third data feedback for the third data transmission.

Aspect 28 is an apparatus for wireless communication at a network entity including at least one processor coupled to a memory and configured to implement any of aspects 19 to 27.

In aspect 29, the apparatus of aspect 28 further includes at least one antenna coupled to the at least one processor.

In aspect 30, the apparatus of aspect 28 or 29 further includes a transceiver coupled to the at least one processor.

Aspect 31 is an apparatus for wireless communication including means for implementing any of aspects 19 to 27.

In aspect 32, the apparatus of aspect 31 further includes at least one antenna coupled to the means to perform the method of any of aspects 19 to 27.

In aspect 33, the apparatus of aspect 31 or 32 further includes a transceiver coupled to the means to perform the method of any of aspects 19 to 27.

Aspect 34 is a non-transitory computer-readable storage medium storing computer executable code, where the code, when executed, causes a processor to implement any of aspects 19 to 27.

What is claimed is:

1. An apparatus for wireless communication at a user equipment (UE), comprising:
a memory; and
at least one processor coupled to the memory, the at least one processor configured to:
receive, before a radio resource control (RRC) configuration procedure or an RRC reconfiguration procedure, a first communication scheduling a first data transmission with associated feedback, the first communication including first information associated with the first data transmission and a first redundancy version indicator (rv Index);
attempt to receive the first data transmission based on the first information; and
transmit, based on the first rv Index, a first quantity of repetitions of first data feedback for the first data transmission.

2. The apparatus of claim 1, wherein the first rv Index maps to the first quantity of the repetitions.

3. The apparatus of claim 2, further comprising:
at least one antenna coupled to the at least one processor, wherein the at least one processor is further configured to:
receive a configuration configuring a mapping between the first rv Index and the first quantity of the repetitions.

4. The apparatus of claim 1, wherein the at least one processor is further configured to:
receive an indication of a set of repetition factors, the set of repetition factors including at least two values, and wherein the set of repetition factors includes the first quantity of the repetitions.

5. The apparatus of claim 1, wherein to attempt to receive the first data transmission, the at least one processor is configured to:
apply a second rv Index to a physical downlink shared channel (PDSCH) transmission received based on the first information, wherein the second rv Index is a configured value applied to a new data transmission.

6. The apparatus of claim 1, wherein to attempt to receive the first data transmission, the at least one processor is configured to:
apply the first rv Index to a physical downlink shared channel (PDSCH) transmission received based on the first information.

7. The apparatus of claim 1, wherein the at least one processor is further configured to:
store the first rv Index of the first communication;
receive a second communication scheduling a second data transmission, the second communication including second information for reception of the second data transmission and a second rv Index, wherein the second data transmission is a retransmission of the first data transmission;
attempt to receive the second data transmission based on the second information; and
transmit the first quantity of the repetitions of second data feedback for the second data transmission based on the first rv Index.

8. The apparatus of claim 1, wherein the at least one processor is further configured to:
indicate that the UE supports a capability to transmit one or more repetitions of data feedback; and
use the first rv Index to determine the first quantity of the repetitions based on support for the capability.

9. The apparatus of claim 1, wherein the at least one processor is further configured to:
skip transmission of capability information indicating that the UE supports a capability to transmit one or more repetitions of data feedback; and
transmit one repetition of the first data feedback.

10. A method of wireless communication at a user equipment (UE), comprising:
receiving, before performing a radio resource control (RRC) configuration procedure or an RRC reconfiguration procedure, a first communication scheduling a first data transmission with associated feedback, the first communication including first information associated with the first data transmission and a first redundancy version indicator (rv Index);
attempting to receive the first data transmission based on the first information; and
transmitting, based on the first rv Index, a first quantity of repetitions of first data feedback for the first data transmission.

11. The method of claim 10, wherein the first rv Index maps to the first quantity of the repetitions.

12. The method of claim 11, further comprising:
receiving a configuration configuring a mapping between the first rv Index and the first quantity of the repetitions.

13. The method of claim 10, further comprising:
receiving an indication of a set of repetition factors, the set of repetition factors including at least two values, and wherein the set of repetition factors includes the first quantity of the repetitions.

14. The method of claim 10, wherein attempting to receive the first data transmission includes:
applying a second rv Index to a physical downlink shared channel (PDSCH) transmission received based on the first information, wherein the second rv Index is a configured value applied to a new data transmission.

15. The method of claim 10, wherein attempting to receive the first data transmission includes:
applying the first rv Index to a physical downlink shared channel (PDSCH) transmission received based on the first information.

16. The method of claim 10, further comprising:
storing the first rv Index of the first communication;
receiving a second communication scheduling a second data transmission, the second communication including second information for receiving the second data transmission and a second rv Index, wherein the second data transmission is a retransmission of the first data transmission;
attempting to receive the second data transmission based on the second information; and
transmitting the first quantity of the repetitions of second data feedback for the second data transmission based on the first rv Index.

17. The method of claim 10, further comprising:
indicating that the UE supports a capability to transmit one or more repetitions of data feedback; and
using the first rv Index to determine the first quantity of the repetitions based on support for the capability.

18. The method of claim 10, further comprising:
skipping transmission of capability information indicating that the UE supports a capability to transmit one or more repetitions of data feedback; and
transmitting one repetition of the first data feedback.

19. An apparatus for wireless communication at a network entity, comprising:
a memory; and
at least one processor coupled to the memory, the at least one processor configured to:
output, before a radio resource control (RRC) configuration procedure or an RRC reconfiguration procedure, a first communication scheduling a first data transmission with associated feedback, the first communication including first information for reception of the first data transmission and a first redundancy version indicator (rv Index);
output the first data transmission based on the first information; and
obtain, based on the first rv Index, a first quantity of repetitions of first data feedback for the first data transmission.

20. The apparatus of claim 19, wherein the first rv Index maps to the first quantity of the repetitions.

21. The apparatus of claim 20, further comprising:
at least one antenna coupled to the at least one processor, wherein the at least one processor is further configured to:
configure a mapping between the first rv Index and the first quantity of the repetitions.

22. The apparatus of claim 19, wherein the at least one processor is further configured to:
configure a set of repetition factors, the set of repetition factors including at least two values, and wherein the set of repetition factors includes the first quantity of the repetitions.

23. The apparatus of claim 19, wherein the at least one processor is further configured to:
output a second communication scheduling a second data transmission, the second communication including second information for reception of the second data transmission and a second rv Index, wherein the second data transmission is a retransmission of the first data transmission;
output the second data transmission based on the second information; and
obtain the first quantity of the repetitions of second data feedback for the second data transmission.

24. The apparatus of claim 19, wherein the at least one processor is further configured to:
obtain an indication that a user equipment (UE) supports a capability to transmit one or more repetitions of data feedback; and
monitor for the first quantity of the repetitions of the first data feedback based on the capability.

25. The apparatus of claim 19, wherein the at least one processor is further configured to:
output a second communication scheduling a second data transmission, the second communication including second information for reception of the second data transmission and a second rv Index, wherein the second data transmission is a first new data transmission;
output a third communication scheduling a third data transmission based on an absence of detecting second data feedback for the second data transmission, the third communication including third information for reception of the third data transmission and a third rv Index, wherein the third data transmission is a second new data transmission; and
monitor, based on the third rv Index, for a second quantity of repetitions of third data feedback for the third data transmission.

26. The apparatus of claim 19, wherein the at least one processor is further configured to:
output a second communication scheduling a second data transmission, the second communication including second information for reception of the second data transmission and a second rv Index, wherein the second data transmission is a new data transmission;
output a third communication scheduling a third data transmission based on an absence of detecting second data feedback for the second data transmission, the third communication including third information for reception of the third data transmission and a third rv Index, wherein the third data transmission is a retransmission of the second data transmission; and
monitor, based on the third rv Index, for a second quantity of repetitions of third data feedback for the third data transmission.

27. A method of wireless communication at a network entity, comprising:
outputting, before performing a radio resource control (RRC) configuration procedure or an RRC reconfiguration procedure, a first communication scheduling a first data transmission with associated feedback, the first communication including first information associated with the first data transmission and a first redundancy version indicator (rv Index);
outputting the first data transmission based on the first information; and
obtaining, based on the first rv Index, a first quantity of repetitions of first data feedback for the first data transmission.

28. The method of claim 27, further comprising:
configuring a set of repetition factors, the set of repetition factors including at least two values, and wherein the set of repetition factors includes the first quantity of the repetitions.

29. The method of claim 27, further comprising:
outputting a second communication scheduling a second data transmission, the second communication including second information for receiving the second data transmission and a second rv Index, wherein the second data transmission is a retransmission of the first data transmission;
outputting the second data transmission based on the second information; and
obtaining the first quantity of the repetitions of second data feedback for the second data transmission.

30. The method of claim 27, further comprising:
outputting a second communication scheduling a second data transmission, the second communication including second information for receiving the second data transmission and a second rv Index, wherein the second data transmission is a new data transmission;
outputting a third communication scheduling a third data transmission based on an absence of detecting second data feedback for the second data transmission, the third communication including third information for receiving the third data transmission and a third rv Index, wherein the third data transmission is a retransmission of the second data transmission; and
monitoring, based on the third rv Index, for a second quantity of repetitions of third data feedback for the third data transmission.
